(19) United States
(12) Patent Application Publication
(10) Pub. No.: US 2008/0288282 A1
(43) Pub. Date: Nov. 20, 2008

(54) METHOD AND SYSTEM FOR REDUCING THE INCIDENCE OF DEFENSIVE MEDICINE

(75) Inventor: Jeffrey J. Segal, Greensboro, NC (US)

Correspondence Address: ROPES & GRAY LLP, PATENT DOCKETING 39/361, 1211 AVENUE OF THE AMERICAS, NEW YORK, NY, 10036-8704, US

(73) Assignee: MEDICAL JUSTICE CORP., Greensboro, NC (US)

(21) Appl. No.: 11/940,052

(22) Filed: Nov. 14, 2007

Related U.S. Application Data
(60) Provisional application No. 60/938,793, filed on May 18, 2007.

(51) Int. Cl. G06Q 50/00; G06Q 40/00

(52) U.S. Cl. 705/2; 705/4

(57) ABSTRACT

Methods and systems are described that implement evidence-based schemata in a health care system that embody practice guidelines and/or a standard of care. Physicians in the health care system agree to adhere to the practice guidelines. An insured patient transfers the right to sue a physician malpractice to a neutral third party and receives medical care in compliance with the practice guidelines. The insured patient may be subject to incentives and disincentives to encourage compliance with the transfer agreement. Shielding the physician from lawsuits will give the physician an incentive to abandon the practice of “defensive medicine.” This will significantly reduce the number of diagnostic tests and procedures and associated risks and expenses. Such a system can promote cost-efficiency, increase safety and provide fair remedies to patients who are injured, regardless of the cause.

### CROSS REFERENCE TO RELATED APPLICATION

This claims the benefit of copending U.S. Provisional Patent Application No. 60/938,793, filed May 18, 2007, the contents of which are hereby incorporated by reference herein in their entirety.

### BACKGROUND OF THE INVENTION

This invention relates to managing professional liability claims, in particular liability claims from patients against health care providers. More particularly, this invention relates to the provision of setting a cost-effective, evidence-based, predefined standard of care which when followed by the physicians will shield the physicians from tort actions. Tangible benefits may be offered to an insured in exchange for the insured's consent to assign/subrogate claims. Tangible benefits may be also offered to physicians above and beyond immunity from lawsuits.

As society has become more litigious, professionals, in particular in the medical community, have found themselves defending an increasing number of professional liability claims brought by patients unhappy with the quality of the professional services rendered, or with the results of those services. Such services include medical evaluation before any treatment, diagnostic tests and acute and chronic care. Physicians frequently face the accusation of having “missed” a diagnosis for failure to perform a series of exhaustive tests, which, in the eye of the patient, would have changed the clinical outcome. In some cases, such charges of professional misconduct are warranted. However, in many more cases, the charges are unwarranted. Despite competent services rendered at or above the standard of care, concern and attention, and without fault on the part of the professional, the desired result may not be achieved in all cases.

As a result, physicians have been subjected to ever-increasing premiums for liability insurance to defend against such charges of misconduct. As some of these costs must be passed on to consumers (patients), this also has resulted in increased health insurance premiums. More importantly, health insurance premiums for consumers (patients) have risen because of the increasingly widespread practice of “defensive medicine” by physicians seeking to avoid potential allegations by patients that not everything humanly possible was done to avoid an untoward result.

Ideally, physicians (as used herein, unless otherwise indicated, the terms “physician,” “medical care provider,” “health care provider” and “medical service provider” should be interpreted to include any medical practitioner, professional or entity, such as a hospital, that is potentially subject to suit) should provide services, including the administration of diagnostic tests, primarily to care for their patients. However, in defensive medicine, services are provided and tests are administered even when not medically indicated, simply to avoid litigation. In addition, experimental therapies, and treatment modalities that are increasingly sophisticated, requiring trained personnel, special equipment, time and resources are frequently used. However, such care generally does not provide value to the vast majority of patients. On the contrary, such care often exposes the patient to extra risks and adds significant costs to the care with at most marginal potential for positively changing the diagnosis or the outcome of treatment. However, practicing defensive medicine may allow the physician to more successfully defend against allegations that he/she failed to order a potentially vital test or therapy which could have prevented the adverse outcome for the patient.

The practice of defensive medicine is pervasive and costly, and estimated to add between $70 billion and $126 billion per year to the cost of providing health care in the United States. The practice of defensive medicine also is strongly correlated to the practice of medicine in states with perceived “plaintiff- or patient friendly ”tort environments. Not surprisingly, professional liability carriers in these states also charge physicians higher malpractice insurance premiums that in states with “defendent- or doctoer-friendly” tort enviroments, Defensive medicine is likewise more prevalent in states whose physicians, matched specialty for specialty, are being charged higher professional liability premiums. Defensive medicine, then, is seen by physicians not only as a way to reduce the threat of litigation, but also as a way for a professional to satisfy his/her professional liability insurer that he/she is a lower claims risk, in an attempt to avoid even higher premiums.

For these reasons it would be desirable to provide a system that would allow all parties, i.e., patients, health care providers, health insurance carriers and optionally also liability insurance carriers, to participate in a health care system where each party benefits.

### SUMMARY OF THE INVENTION

In accordance with the present invention, appropriate diagnostic procedures and treatments for various medical conditions are established by certain pre-defined schemata. Use of these predefined schemata preferably creates a rebuttable, or even irrebuttable, presumption that an appropriate standard of care was applied. Agreements between health insurers and their customers (patients) make this standard of care the cost-effective standard to which physicians will be held accountable. Preferably, physicians also participate in those agreements.

An example of such a schema is the “Canadian CT Head Rule for patients with minor head injury,” published in Lancet, No. 357, pp. 1391-96 (May 5, 2001). Frequently, physicians, fearful of missing a treatable lesion after minor head injury, will order a CT scan of the patient's head. Most of these scans show no evidence of a treatable lesion. The Canadian CT Head Rule was developed as highly sensitive decision rules to guide physicians who treat patients with minor head injury. The Canadian CT Head Rule is based on the occurrence of any one of five high-risk factors—failure to reach Glasgow Coma Score of 15 (normal) within 2 hours; suspected open skull fracture; any sign of basal skull fracture; more than two vomiting episodes; age over 65 years—and two additional medium-risk factors—amnesia for events occurring more than 30 minutes prior to impact; dangerous mechanism of injury. In a study on which the rule was based, the high-risk factors were 100% sensitive (95%, acceptably narrow confidence interval range of 92-100%) and 68.7% specific for predicting a need for neurosurgical intervention, and would require only 32% of patients to undergo CT. That is, the use of one or more of these high risk factors as criteria for administering a CT scan in a case of minor head injury allowed the researchers to avoid missing any patients who needed neurosurgical intervention. A second part of the study examined supplementing the high risk factors with the two medium risk factors, so that occurrence of any one high risk factor or medium risk factor would necessitate a CT scan. Use of these criteria demonstrated 98.4% sensitivity (95%, acceptably narrow confidence interval range of 96-99%) and 49.6% specificity for predicting clinically important brain injury, and required 54% of patients to undergo a CT scan. Adding the medium risk factors to the screening criteria did little to improve sensitivity, while lowering specificity and adding to the cost. In any event, use of such a schema (either variant) would focus intervention on those likely to need it, sparing those unlikely to benefit from being subjected to cost-inefficient procedures that also may expose them unnecessarily to radiation.

Thus, in accordance with the invention, if the Canadian CT Head Rule were an accepted schema for diagnosing patients with a head injury, and such a patient were treated in accordance with that rule, the treating physician would be presumed (at least rebuttably) to have acted properly. This would be a defense to a charge of malpractice.

In one embodiment, based on the provision of cost-effective, safe care, a patient agrees to subrogate or assign, to the patient's health insurance carrier, the patient's right to sue for medical negligence. In exchange for agreeing to subrogate or assign medical negligence claims, the patient may receive as consideration a number of benefits in return. For example, the patient may receive any one or more of a reduction of the patient's health insurance premiums, a subsidy for disability, life or long-term care insurance or such insurance itself (to address untoward outcomes), a guarantee for patient-safety systems, a guarantee of future medical care if rendered care was negligent or grossly negligent, and the like. Finally, the patient may receive at least a portion of any monetary settlement or recovery related to claims that the health insurance carrier, exercising its assigned or subrogated rights, might have against physicians who provided negligent or grossly negligent care. The health insurance premium charged the consumer/patient preferably will reflect the rights foregone as well as any enhanced benefits.

Physicians also benefit because they are no longer exposed to the capriciousness of meritless claims that might be brought by a patient, insofar as only the health insurance carrier can file suit. And according to the system described, if a physician follows the evidence-based schemata or guidelines, the physician preferably would have absolute, or at least qualified, immunity from suit, even by the health insurance carrier. That is, a claim would have no merit if advanced against a physician who followed the guidelines. The health insurance carrier, as the owner of a potential claim (by assignment or subrogation) would be forced to adhere to rules to which all parties have agreed. Whereas a patient who was injured might want to advance a claim for a variety of reasons, it is only the health insurance carrier that can advance a claim. If a physician adhered to the guidelines, the rules mandate that such a claim will never be pursued.

Even if the physician did not follow the guidelines, the physician may nevertheless have less exposure than in a case where the patient could sue, depending upon how much benefit/consideration the patient/consumer received in exchange for agreeing to subrogation or assignment. For example, even if a claim has merit because the physician acted negligently and did not adhere to the accepted evidence-based schema determining the standard of care, the heath insurance policy may dictate that the damages be lower (e.g., they may be capped) and/or more predictable. And if the patient/consumer received even more benefit or consideration up front, then even though a claim has merit, the health insurance policy may dictate that it could only be pursued if triggered by a higher threshold, such as gross negligence.

Thus, physicians are encouraged to follow an evidence-based standard of care based on the schemata or guidelines, as it provides qualified or absolute immunity against malpractice lawsuits. Even if a physician fails to follow the guidelines, the frequency or severity of resulting lawsuits will be lower than in the conventional tort system, because the patient selects a particular threshold for filing a suit (negligence or gross negligence). Moreover, the amount of potential damages may be reduced because the patient may have accepted a particular level of damages depending upon the benefit/consideration selected when the patient agreed to participate in the system.

The system does not require any agreement on the part of the physician. The physician will simply recognize that a patient has this type of insurance, and knowing that will allow the physician to know that in treating this particular patient, following the schemata will protect the physician. Therefore, the physician will be less likely to practice defensive medicine.

Preferably, however, there also is an agreement between the physician and the health insurance carrier, wherein the physician agrees that care will be guided by an explicit standard of care determined by the evidence-based schemata. By establishing an accepted standard of care to be adhered to by the physicians, health insurance carriers will be able to positively influence physicians to avoid practicing defensive medicine. In doing so, costs will be kept down, and money in the system can be redeployed to provide other benefits mentioned above. As an added incentive, physicians can be paid subsidies, stipends, bonuses, higher compensation or other benefits for consistently adhering to the standard of care determined by the evidence-based schemata.

In short, the needs of each party—i.e., of patients, physicians and health insurance carrier—are met without exposing the parties directly to the costly inefficiencies of the traditional tort system.

In the foregoing embodiments, the patient assigns or subrogates to the health insurance carrier any claim that may arise against a health care provider. However, health insurance carriers may not want to be in an adversarial position relative to health care providers. One consequence of such an adversarial relationship might be that a health care provider would not participate in health insurance plans offered by that carrier, making that carrier's plans less attractive to potential purchasers of health insurance coverage. Therefore, in a further embodiment, in accordance with the present invention, the system may include an arrangement where the patient agrees to transfer any claim that may arise against a health care provider to a “neutral” entity, separate from the health insurance carrier. The neutral entity can be a truly independent third party, or could be a separate corporate entity that may share at least partial common ownership with the health care provider. The “transfer” of the claim in such an embodiment could include an assignment of the claim to be pursued by the neutral entity on its own behalf or for the benefit of the patient, or merely a referral of the claim to the neutral entity for evaluation of whether the health care provider followed the relevant schema or schemata, with the patient pursuing any claim on his or her own following that review. “Transfer” also may include any other right—e.g., power of attorney—to pursue the claim or to recover some or all of the proceeds—i.e., any settlement or damage award—of the claim.

As used herein, “health insurance carrier” includes, but is not limited to, (a) third party indemnity insurance companies that pay for health services, or claims for health services, in exchange for premiums, (b) managed care organizations, (c) businesses which self-insure in part or in full to pay for health services, or claims for health services, for employees or retirees, and/or (c) any government entity that pays for health services or claims for health services.

### BRIEF DESCRIPTION OF THE DRAWINGS

The above and other objects and advantages of the invention will be apparent from the following detailed description, taken in conjunction with the accompanying drawings, in which like reference characters refer to like parts throughout and in which:

FIG. 1 is a schematic diagram showing a closed health care system;

FIG. 2 is a flow diagram of a method according to one embodiment;

FIG. 3 is a graphical representation of benefits derived when medical tests are administered according to accepted practice guidelines;

FIG. 4 is a schematic diagram of an “open” health care system;

FIG. 5 is a schematic diagram showing a closed health care system according to an embodiment of the present invention;

FIG. 6 is a schematic diagram showing an open health care system according to another embodiment of the present invention;

FIGS. 7 and 7A (hereinafter collectively referred to as FIG. 7) is a flow diagram of a method according to the invention; and

FIG. 8 is a schematic view of a preferred embodiment of a hardware system for implementing the present invention.

### DETAILED DESCRIPTION

In systems in which the present invention may be used, practice guidelines or schemata derived from an evidence-based standard of care are established. By “evidence-based” is meant that the standard of care is based on analysis of statistics involving prior patients suffering from similar conditions and the results of various diagnostic procedures and treatments administered to such patients. Such a standard of care is presumed to provide reasonable levels of safety for patients, but also to be cost-effective.

In such a system, health insurance carriers preferably make these standards of care part of at least one form of coverage offered to prospective insures (patients/consumers). Any patient who purchases that form of coverage understands and agrees that (1) the patient's right to sue for medical malpractice is subrogated or assigned to the health insurance carrier, and (2) the carrier will not initiate a malpractice action against any medical service provider (e.g., physician) who follows the schemata. In addition, or as an alternative, to offering such a form of coverage at a lower premium (because of expected overall savings resulting from reducing or eliminating defensive medical practices), the health insurance carrier may offer the subscriber additional incentives as described above and discussed in more detail below.

Just as medical service providers currently recognize various types of patient coverage such as traditional indemnity plans and the various forms of managed care (i.e., HMO, POS and PPO plans), so too will medical service providers learn to recognize plans according to the invention. When a medical service provider encounters a patient who subscribes to a form of coverage in accordance with such a system, the provider preferably will know that defensive medical practices will not be necessary with this patient, as long as the patient's carrier's published schemata are followed.

In another embodiment, health insurance carriers can demand that the schemata be followed. These embodiments apply primarily to managed-care arrangements where health insurance carriers already enter into contracts with medical service providers. In accordance with this embodiment, such contracts preferably would include a requirement of adherence by the medical service provider to the standards of care embodied in the published schemata. In exchange, the health insurance carrier preferably agrees not to initiate any malpractice action against the medical service provider on a subrogated claim as long as the schemata are followed. Thus, a physician following the guidelines will be shielded from lawsuits by a patient alleging incompetent or inadequate care.

If a physician or other medical service provider does not adhere to the guidelines, and the patient is injured, the provider will be at risk for a lawsuit. A physician may be adjudged to have failed to adhere to the schemata by either (a) failing to comply with the base minimum called for by the schemata, or (b) providing excessive, unnecessary care. Thus, defensive medical practices may actually be a violation of the agreed-upon standard of care. In that sense, there is an optimum window of care that will shield the provider from a lawsuit. In the aforementioned example of the Canadian CT Head Rule, lack of compliance with the guidelines may be found if (a) a physician fails to order a CT of the head after minor injury in a patient with the identified risk factor(s), or (b) a physician orders a CT of the head after minor injury in a patient without the identified risk factors. Failure to comply with guidelines does not mean that there will necessarily be a lawsuit. However, compliance with the guidelines preferably does mean that a lawsuit will be avoided.

The standard of care will include guidelines or schemata for diagnostic procedures as well as guidelines for referral and for treatment. In the aforementioned example of the Canadian Head CT Rule, the rules were developed precisely to balance the competing aims of cost-containment, safety, and fear of litigation.

Defensive medicine, with its ever-increasing effect on rising health care costs, includes the use of diagnostic tests (such as costly imaging procedures), referrals and therapies to avoid being sued for negligence. Such defensive medicine is generally considered to be care that does not ordinarily have any recognizable benefits for the patient.

However, defensive medicine has other components. For example, out of fear of litigation, a medical service provider may avoid certain high-risk procedures, and also may avoid “problem” patients who are perceived by the provider to elevate the probability of the provider being sued. Thus, for example, physicians have avoided performing procedures having a high frequency of complications, such as trauma surgery, and also have avoided patients who have complex medical problems or simply are perceived as litigious. Defensive medical practice correlates strongly with physicians' lack of confidence in their states' tort systems and a perceived threat of higher frequency or severity of lawsuits, higher insurance premiums, and even the reportability of any settled or adjudicated claim against the physician to the National Practitioners' Data Bank (“NPDB”).

Studies have shown that “direct” reforms to the liability system which are designed to reduce, or “cap,” the level of compensation to potential claimants reduce medical expenditures without significant negative consequences for patient health outcomes. However, this approach, while helpful, perpetuates the present liability system, leaving medical care providers exposed to lawsuits. That is, a capped settlement may be associated with a lower payout to a plaintiff patient. But the physician (or other provider), while gaining the benefit of lower professional liability insurance premiums, is still exposed to the stress of a lawsuit, with all its effects on the physician's practice, personal life and reputation. Because the risk of frequency of lawsuits is not significantly changed by direct tort reforms, such reforms have not dramatically changed physician behavior in terms of how they practice medicine. Physicians at risk for being sued, even for lower awards or judgments, still practice defensively. Because medical care providers still perceive a need to practice defensively, cost savings from direct tort reforms are not as significant as they could be. If physicians were shielded from not only the severity but also the frequency of lawsuits, they could practice in ways that lower overall systemic costs, thereby lowering premiums for professional liability insurance (for themselves) and lowering premiums for health insurance and/or redeploying savings for other benefits (for patients).

For a system such as that described to achieve its goal of substantial cost savings, it must be acceptable to the public who buy health insurance (or who receive it from employers) that they give up the right to sue for malpractice. Therefore, the system preferably includes incentives for the patient. First, the system preferably assures a patient that he/she can expect to receive medical care according to an accepted standard of care adhered to by the treating physician. Other benefits include a reduction in health insurance premiums. In addition, or alternatively, the health insurance policy may be coupled with a disability and/or long-term care policy for patients whose injuries result in long-term disabilities. Life insurance may be offered to dependents or named beneficiaries. In addition, should there be a recovery by a carrier against a physician, some or all of that recovery might be transferred to the patient, the patient's estate, or a named beneficiary.

The physician remains free to prescribe and administer any suitable diagnostic tests as determined by professional judgment. However, to control expenses, the evidence-based schemata according to the accepted standard of care for arriving at a diagnosis and/or treatment would recommend certain tests. Any additional “defensive” tests would not be expected to change the medical outcome for the patient and would therefore not be expected to be administered on a routine basis. In the event of litigation (brought by the health insurance carrier, not the patient), the physician would have to justify departure from the schemata if any additional tests were administered.

The following table compares various systems to illustrate a system such as that described. The benefits for the health care system depend on the physician's compliance with the diagnostic and treatment schemata and on the threshold for bringing legal action against a physician. The diagnostic and treatment schemata preferably do not depend on a single factor, such as an actual diagnosis, but also take into account other parameters, such as a patient's overall health, age, genetic factors, etc.

| | | | Physician | | | |
|---|---|---|---|---|---|---|
| | | | Compliance | | | |
| | | | With | | | |
| | | Cost of | Diagnostic | Subrogation/ | | |
| | | Health | and | Assignment/ | Threshold | |
| | | Insurance | Treatment | Transfer of | for | Remedy to |
| | | Premium | Algorithms | Rights to | Physician | Patient/ |
| | System | (Rank) | (Rank) | Carrier | being Sued | Carrier |
| A | Traditional | 9 | 1 | None | Threshold: | Claims are |
| | Tort System | (highest) | | | negligence | for economic, |
| | | | | | | non-economic, |
| | | | | | | and punitive |
| | | | | | | damages. |
| B | Subrogation | 8 | 2 | Transfer of | Threshold: | Claims are |
| | “Lite” | | | rights to | negligence | for economic, |
| | (Minimum) | | | carrier | | non-economic, |
| | | | | | | and punitive |
| | | | | | | damages. |
| C | Subrogation | 7 | 3 | Transfer of | Threshold: | Claims are |
| | “Lite” | | | rights to | negligence | for economic, |
| | (Medium 1) | | | carrier | | non-economic |
| | | | | | | damages. |
| D | Subrogation | 6 | 4 | Transfer of | Threshold: | Claims are |
| | “Lite” | | | rights to | negligence | for economic |
| | (Medium 2) | | | carrier | | damages and a |
| | | | | | | cap for non- |
| | | | | | | economic |
| | | | | | | damages. |
| | | | | | | (can be at |
| | | | | | | multiple |
| | | | | | | levels) |
| E | Subrogation | 5 | 5 | Transfer of | Threshold: | Claims are |
| | “Lite” | | | rights to | negligence | for economic |
| | (Maximum) | | | carrier | | damages only |
| F | Subrogation | 4 | 6 | Transfer of | Threshold: | Claims are |
| | Major | | | rights to | Gross | for economic, |
| | (Minimum) | | | carrier | negligence | non-economic, |
| | | | | | | and punitive |
| | | | | | | damages. |
| G | Subrogation | 3 | 7 | Transfer of | Threshold: | Claims are |
| | Major | | | rights to | Gross | for economic, |
| | (Medium 1) | | | carrier | negligence | non-economic |
| | | | | | | damages. |
| H | Subrogation | 2 | 8 | Transfer of | Threshold: | Claims are |
| | Major | | | rights to | Gross | for economic |
| | (Medium 2) | | | carrier | negligence | damages and a |
| | | | | | | cap for non- |
| | | | | | | economic |
| | | | | | | damages. |
| | | | | | | (can be at |
| | | | | | | multiple |
| | | | | | | levels) |
| I | Subrogation | 1 | 9 | Transfer of | Threshold: | Claims are |
| | Major | (lowest) | | rights to | Gross | for economic |
| | (Maximum) | | | carrier | negligence | damages only |

System A is the traditional tort system, while Systems B-I are various forms of a system such as that described. In Systems B-I, the health insurance carrier (via subrogation or assignment or other transfer of rights) controls or owns the right to sue the medical service provider. The carrier might receive a settlement or award from the physician. The plan might provide that the carrier transfer none, some, or all of that settlement or award to the patient (or—e.g., if the patient does not survive—his family or designee). The patient would be expected to pay a lower health insurance premium if the plan provided that none of the settlement or award would be transferred to the patient, and a somewhat higher health insurance premium to preserve the right to receive some or all of the settlement or award.

The most expensive system shown (A), in terms of both health insurance premiums for the patient and potential monetary awards for injuries allegedly sustained by the patient, is the traditional tort system where the patient has not subrogated or transferred any rights and is able to file claims against a physician for economic, non-economic, and punitive damages in the event of negligence, and often recovers damages without actually proving negligence (e.g., through settlement). The physician may not be able to rely definitively on any accepted evidence-based standard of care, and the burden of proof that no negligence occurred may as a practical matter (if not legally) fall on the physician. The physician will therefore want to protect him- or herself from lawsuits by practicing defensive medicine as described above, ordering diagnostic tests in excess of those specified in the schemata based on the accepted cost-effective, evidence-based standard of care.

Conversely, of the systems shown, a patient will pay the lowest health care premium in a system (I) where the insured has transferred or assigned all rights to the health insurance carrier, where the physician agrees to adhere to the diagnostic and treatment schemata defined by the practice guidelines, where the threshold for bringing a lawsuit is gross negligence, and any lawsuit brought by the assignee carrier will be merely for economic damages. In this case, the patient's claims, which were assigned to the health insurance carrier, will be limited to economic damages only, and will be paid to the health insurance carrier. In other words, the insured can choose the lowest possible premium and thereby opt out of any direct settlement or award, even for injuries related to gross negligence.

In this system I, the health insurance carrier, as the assignee of the patient's rights, might transfer none, some, or all of the economic damages awarded to the patient. The lowest health insurance premium for the patient would be based on the carrier keeping all of the award and transferring none of that award to the patient. The patient would pay a somewhat more expensive health insurance premium for a policy under which the carrier will transfer some or all of any settlement or award back to the patient.

Regardless of the variety of system I chosen by the patient, system I is the least expensive of the systems shown because any settlement or award would be for economic damages only and would be based on a gross negligence threshold. Valuable benefits other than decreased health insurance premiums can accrue to such patients. System I allows the maximum increase in incentives to patients, such as the most decreased premiums or most increased aggregate other benefits, as compared to the other systems shown. System A allows for the least increase in incentives to patients, such as least decreased premiums or the least increased aggregate other benefits, as compared to the other systems shown.

Under systems H, G, and F, where the threshold is still gross negligence, damages could include (limited) non-economic damages (system H) or even punitive damages (system F) in addition to economic damages. As expected, such systems result in lower overall savings. The insured would pay a higher premium and at least some non-economic and even punitive damages may be awarded to the carrier. Preferably, such damages would be capped at, e.g., $250,000 for non-economic damages. That number is considered by many physicians to be a desirable limit and is a common standard for non-economic damages in states that have pursued tort reform. However, even under such a system, there still may be significant savings as compared to the traditional tort system (A). Again, the carrier, as the assignee/transferer of the patient's rights, might transfer none, some, or all of the economic damages and capped or uncapped non-economic damages, whether received from a settlement or award, to the patient. The higher the amount that could potentially be transferred, the higher the patient's premium would be.

Somewhere in the middle are systems (B, C, D, and E) in which patients would subrogate or assign or otherwise transfer potential claims to the health insurance carrier, and medical service providers would be expected to adhere to the evidence-based standard of care embodied in the carrier's schemata or guidelines. In system B, damages are similar to those in the traditional tort system, but the carrier controls any claim. As an institution, the carrier is likely to be more consistent (and predictable) than an individual patient claimant, hence creating the potential for lower overall claims severity. In systems C, D, and E damages are more limited than in the traditional tort system (A), but the lawsuit threshold where the standard of care was not adhered to remains ordinary negligence. In these systems, the damages are lower than they would be in the traditional tort system (system A). But because the lawsuit threshold is unchanged from system A, the frequency of lawsuits will be similar to the status quo. On the other hand, the severity of lawsuits (as measured by size of judgments or settlements) will be lower. Because the frequency of lawsuits will not be significantly decreased, the physician will continue to practice in fear of being sued. Accordingly, the physician will be less likely to adhere to the evidence-based standard of care embodied in the schemata by performing a minimum number of tests. More likely, the physician will instead be inclined to practice some level of defensive medicine. Accordingly, such systems, while presenting some savings, are less likely to achieve the same reduction in defensive medical practices as systems F-I.

In exchange for assigning or otherwise transferring his/her rights to the health insurance carrier, the patient receives care in accordance with schemata guided by an accepted evidence-based standard of care. The carrier and not the patient may recover damages directly only if the physician acted with ordinary or gross negligence. Rules agreed to by the carrier and patient will determine how much, if any, of those damages might be transferred back to the patient.

It should be noted that there is no way to absolutely stop an aggrieved patient from attempting to file a lawsuit notwithstanding the assignment/subrogation agreement. However, the patient may be subject to disincentives if he/she attempts to ignore the terms of the assignment/subrogation agreement and attempts to initiate a lawsuit. For example, the patient may be subject to any one or more of liquidated damages, attorneys fees, denial of continued medical insurance coverage, and combinations thereof.

The system described thus produces substantial overall cost savings for the health care system by giving the physicians an incentive to forego, or at least reduce, the practice of defensive medicine. It will be understood, however, that the patient, by purchasing an insurance product in accordance with such a system, would have to agree, in exchange for a lower premium and/or other benefits, to subrogation, assignment or other transfer of claims, and to the tort threshold that would be applied in determining liability (e.g., “negligence” or “gross negligence”). The patient may also have to agree to amounts for which the physician would be liable—e.g., economic damages only, economic damages plus capped non-economic and/or punitive damages, etc. The patient would further have to agree whether any damages potentially recovered, which would belong to the carrier, would be transferred to the patient. Even if the patient buys a policy that does not transfer any of the damages, the patient may still be asked to select the tort threshold, because the patient may feel “safer” or “less safe” knowing that the physician will be held to a certain threshold.

A method implementing such a system preferably would:

1. Decrease exposure of physicians to the tort liability system (by decreasing the frequency and/or the severity of lawsuits);

2. Provide an incentive to physicians to not practice defensive medicine;

3. Make the health care system safer for patients by reducing risks from unnecessary procedures and tests;

4. Make the health care system safer by freeing up wasted money to implement patient safety systems in doctor's offices, hospitals, etc., as described below.

5. Provide varying levels of damages for a patient's injuries, from no damages at all, to a transfer to the patient of some or all of the damages collected by or for the health insurance carrier. Supplemental coverage might be provided in the form of disability, life and /or long-term care insurance paid for at least in part by the carrier to provide a remedy for injury to the patient.

In particular, the health insurance carrier, having received the assigned/subrogated rights may do one or more of the following for an injured patient:

1. Provide the patient with benefits up-front in the form of lower health insurance premiums. However, not compensating the patient for even actual economic damage (such as lost wages) may require significant consideration. However, there are precedents for requiring patients to forego all of their rights to sue for medical negligence (such as active duty military personnel).

2. Provide the patient with supplemental coverage in the form of subsidized or fully-paid disability, life and/or long-term care insurance in the event of injury. These benefits would presumably “make the patient whole” and would be provided outside of the tort system. There could be gradation of such supplemental policies, depending on the level of premium paid. The most unrestricted supplemental policy, once issued, would pay benefits regardless of whether occurrence of the event insured against under the supplemental policy is the result of treatment for a condition covered by the underlying health insurance policy. A more restrictive supplemental policy would pay benefits only if the event insured against under the supplemental policy is associated with a condition being treated by a physician under the underlying health insurance policy, but regardless of fault. A more highly restrictive supplemental policy would pay benefits only if the event insured against under the supplemental policy is associated with a condition being treated by a physician under the underlying health insurance policy and the physician did not adhere to the appropriate schema, whether or not that amounted to any form of negligence. A most restrictive supplemental policy would pay benefits only if the event insured against under the supplemental policy is associated with a condition being treated by a physician under the underlying health insurance policy, the physician did not adhere to the appropriate schema, and that failure to adhere to the schema amounted to a specified type of negligence (ordinary or gross). Other gradations may be possible.

3. Provide the patient with additional medical care or paid-up health insurance premiums. This benefit might be provided, e.g., only for an injured patient who can no longer work and therefore can no longer pay for insurance, or might be provided whenever the physician violated a schema (paid for, e.g., by damages recovered from the physician by the health insurance carrier).

4. Provide the patient with some or all of the settlement or judgment received from the medical care provider.

This generally would result in:

1. Lower health insurance premiums, thus making health insurance more affordable and decreasing the number of uninsured or underinsured patients.

2. Lower costs related to defending physicians, because the assignment/subrogation would prohibit lawsuits for care that complies with the accepted evidence-based standard of care embodied in the schemata, and will reduce the frequency and/or severity of lawsuits alleging negligent care.

3. Freeing up of capital within the health care system to implement substantive patient safety systems.

Although the assignment/subrogation of rights, and the high threshold for suing a physician, in accordance with the system described, should encourage physician compliance with the diagnostic and treatment schemata, which should reduce the expensive practice of defensive medicine, there is no way to absolutely prevent an aggrieved patient from filing a lawsuit, notwithstanding any agreement the patient may have made with the health insurance carrier. However, the assignment/subrogation provisions of the policy may also includes provisions to dissuade the patient from initiating individual legal action against a physician. Such provisions may include patient/insured liability for liquidated damages or attorney's fees, cancellation of medical coverage, and the like, in the event of the filing of a lawsuit, which would be a breach of the insurance contract.

Subrogating or assigning claims to the health insurance carrier will remove a claim by a patient from the traditional tort system. In medical malpractice cases, the traditional tort system aims to deter negligence and to make the injured patient whole. Many believe it does neither well. There are no data supporting the contention that states which limit damages (with caps on non-economic damages, for example) encourage progressively higher levels of ordinary negligence. Hence, it is unclear that the threat of litigation, in and of itself, makes patients safer. Further, the tort system dispenses remedies unequally. Two individuals in the same state with the same injury are likely to receive a different remedy. Both will require significant resources to prove their claims. And it will likely take years to receive their remedies, if any are received at all. Hence, the traditional tort system fails to achieve either of its major goals. The described system does not ignore those goals. On the contrary, it frees up funds to potentially (a) implement patient safety systems—systems that health systems currently view as expensive and not contributing to their bottom line; and (b) provide subsidies for disability, life or long-term care insurance policies which can provide predictable funds to injured patients or their families relatively quickly without the burden of having to prove fault or negligence. Finally, because the blame experienced by any one physician is decreased, all physicians are encouraged to disclose openly and honestly when they make mistakes or experience “near-hits.” Such disclosure makes it more likely that system flaws can be identified in a timely fashion and corrected for the future.

Model systems will now be described.

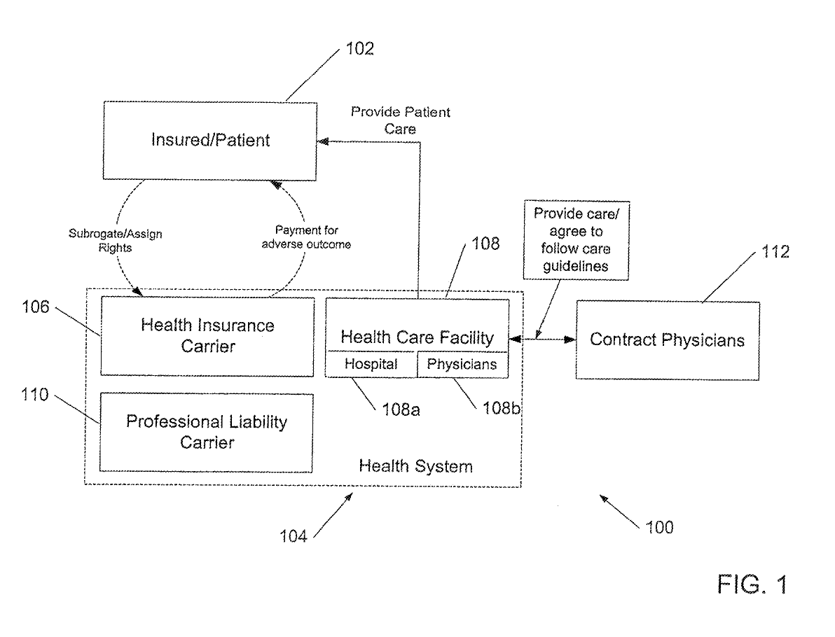

FIG. 1 illustrates schematically an exemplary “closed” system 100 where individuals 102 purchase health insurance coverage from a captive health insurance carrier 106 that is part of an integrated corporate health care system 104. Health care system 104 may include a health care facility 108, such as a hospital 108a, that employs physicians 108b. The health system 104 may also contract with other physicians 112 and other health care facilities. In the exemplary “closed” system 100, the health insurance carrier 106 sets and enforces practice guidelines or schemata to which the caregivers 108, 108a, 108b and 112 must adhere if they wish to participate in health care system 104 and receive reimbursement for their services from health insurance carrier 106. Health care system 104 may also include a captive professional liability carrier 110 to which the physicians 108b, 112 directly or indirectly pay a premium for professional liability insurance.

As described below, patients participating in the exemplary closed system 100 will have assigned/subrogated their rights to directly sue a physician. The professional liability carrier 110 may pay a claim for malpractice to the health insurance carrier 106 (normally after litigation or by settlement). Such a subrogated/assigned claim might be triggered based on a physician 108b, 112 failing to adhere to evidence-based guidelines or schemata. Another threshold for advancing such a claim may be either ordinary or gross negligence. The maximum amount of that claim may vary from (a) economic damages only to (b) economic damages plus capped non-economic damages to (c) economic damages plus capped or uncapped non-economic and punitive damages.

Health care system 104 may or may not be self-insured for malpractice liability of its employees (including physicians and others), which may involve ownership of professional liability carrier 110. If system 104 is self-insured, it may or may not purchase liability insurance to cover events exceeding a certain damage award (stop-loss insurance or reinsurance).

In the closed system 100 of FIG. 1, a patient 102 preferably would purchase health insurance from health insurance carrier 106 and preferably would assign/subrogate to health insurance carrier 106 his/her right to directly sue a physician for negligent or grossly negligent care. The carrier 106 would then have the right to pursue a claim for malpractice against physician 108b, 112. In accordance with the provisions of a particular policy purchased by patient 102, the carrier may transfer some or all of any award/settlement from the physician (paid by the professional liability carrier 110). Whether the policy provides for any such transfer, and what portion of the award or settlement is transferred, will in part determine the premium paid by patient 102. As noted, the bar for any such suit would be based on a specific threshold, which could be either ordinary negligence or gross negligence (e.g., willful conduct).

Preferably, all physicians participating in the closed system 100 will have agreed to, and undergone training to administer tests and perform procedures in conformance with, the practice guidelines and diagnostic and treatment schemata. Indeed, as a group, they may have substantive input into developing the agreed-upon guidelines. As long as the physicians adhere to these guidelines, they will be defended against any direct lawsuits by health insurance carrier 106. Because a physician who follows the practice guidelines will feel less threatened by a lawsuit, he/she will also have less incentive to perform unnecessary tests and procedures—i.e., he/she will refrain from practicing defensive medicine. In addition, the physician might receive other tangible benefits from the carrier for complying with the guidelines, such as bonuses, additional compensation, and the like. Such compliance could be measured by audits and the benefits conferred would be based on how well the guidelines were followed, as determined by an established metric.

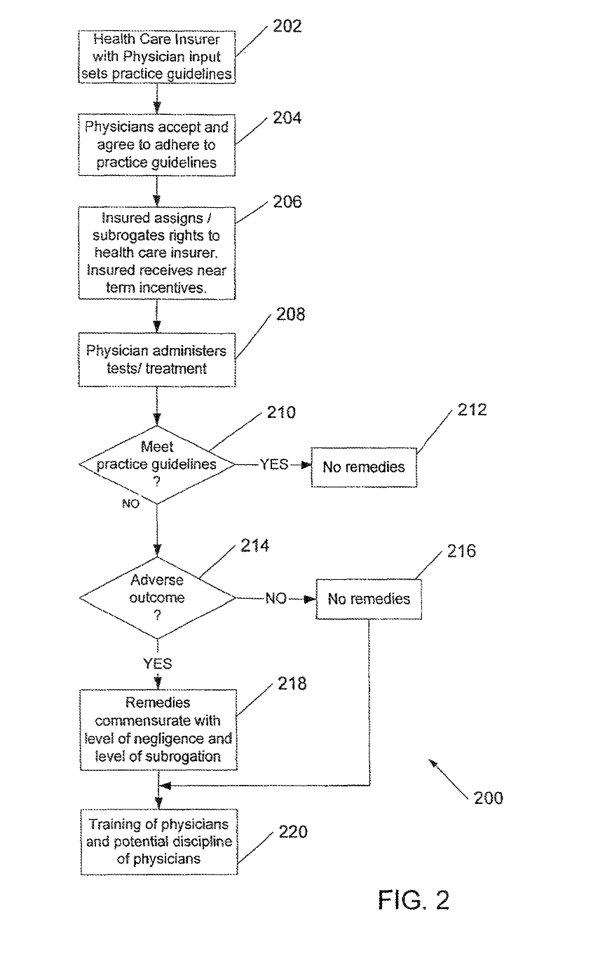

FIG. 2 shows in the form of a process flow chart an exemplary process 200 for administering a system such as system 100 of FIG. 1. At step 202, the health care insurer (preferably with physician input) sets practice guidelines or defines diagnostic and treatment schemata, and the physicians participating in the health system agree at step 204 to follow the guidelines. As a result, a patient can be reasonably assured to receive proper treatment provided that the guidelines are followed. At step 206, an insured/patient assigns/subrogates his rights and agrees that no lawsuit will be brought in his/her name directly or indirectly (e.g., for loss of consortium by a spouse) in the event of an adverse outcome of a treatment. Any claims that could be pursued if the physician did not follow the guidelines would be via the health insurance carrier, as the assignee of any claim (or owner/controller of subrogated rights to make a claim) against the physician.

After assigning/subrogating his/her rights at step 206, the patient will not have any direct cause of action against the physician should he/she be injured. The patient may receive one or more of the following forms of consideration for the assignment/subrogation: (a) lower health insurance premiums; (b) a subsidy for disability, life or long-term insurance; and/or (c) a guarantee that funds are recycled into systems that support or promote patient safety. Further, the health insurance carrier might continue to provide payment for general coverage for the injured patient for some time period in the future (i.e., the carrier might provide continued coverage without the injured patient having to pay additional premiums in the future).

At step 208, the physician in performing his/her duties administers certain tests in compliance with the diagnostic and treatment schemata—i.e., commensurate with a particular diagnosis and set of circumstances (such as the patient's overall health, age, etc.). If all tests and/or treatment meet the guidelines, as determined at test 210, then the patient (or the health insurance carrier on the patient's behalf) would have no cause of action against the physician even if the patient were injured (step 212).

Conversely, if it is determined at test 210 that the tests and/or procedures do not meet the guidelines, and involve negligence or even gross negligence on the part of the physician, but the patient was not harmed (test 214), then the patient would not be entitled to any remedies (step 216). However, the physician may be reprimanded, suspended or expelled, or otherwise disciplined, or be required to undergo additional training on the practice guidelines (step 220).

If the physician acted with ordinary or gross negligence and the patient was harmed (test 214), then the health insurance carrier, as the successor by subrogation/assignment to the patient's potential malpractice claim, may bring suit against the physician (step 218). The threshold for liability on the part of the physician will be ordinary or gross negligence, depending on the patient's policy—i.e., on the nature of the subrogation agreement or assignment, and on the amount of any additional benefits that the patient may have received up front. Similarly, the portion of any damage award or settlement received by the health insurance carrier that is ultimately transferred to the patient, if at all, would depend on the policy as well. It should be remembered, however, that the health insurance carrier's interest in filing suit against the physician is primarily to be reimbursed for medical expenses in treating the injured patient. Thus, the health insurance carrier would normally not be interested in suing for pain and suffering, lost wages, or the like, which are likely to be excluded by the subrogation agreement or assignment. Again, the physician may require additional training and updating on the practice guidelines (step 220), and the process ends.

It is evident that in process 200 few, if any, remedies against the physician are available to a patient alleging improper care if the physician follows the established practice guidelines and treatment schemata. As the physician benefits from substantial immunity by adhering to the guidelines, this will entice the physician to refrain from practicing “defensive medicine.”

In the closed system of FIG. 1, physician care is easily tracked and negligent care is easily documented. To the extent such care can be addressed by patient safety systems, such experiences will serve as examples as to what systems need to be implemented. The implementation of such systems may be paid for from the cost savings resulting from the decreased practice of defensive medicine. Further, should certain individual physicians be determined to present a continued “danger” to patients (for example, due to gross negligence or even willfulness), they may be disciplined, have their privileges curtailed or suspended, or, in rare cases, be terminated. Although these outcomes are little different from the results of standard peer review performed by hospitals or medical licensing boards, in the closed system of FIG. 1, there will be more incentive to locate and publicize deficiencies in the system to improve safety for all patients, because all participants benefit directly or indirectly from exposing deficiencies and acting with candor. For example, physicians may be more open about mistakes, which may improve procedures for the future, if they have less fear of being subject to litigation.

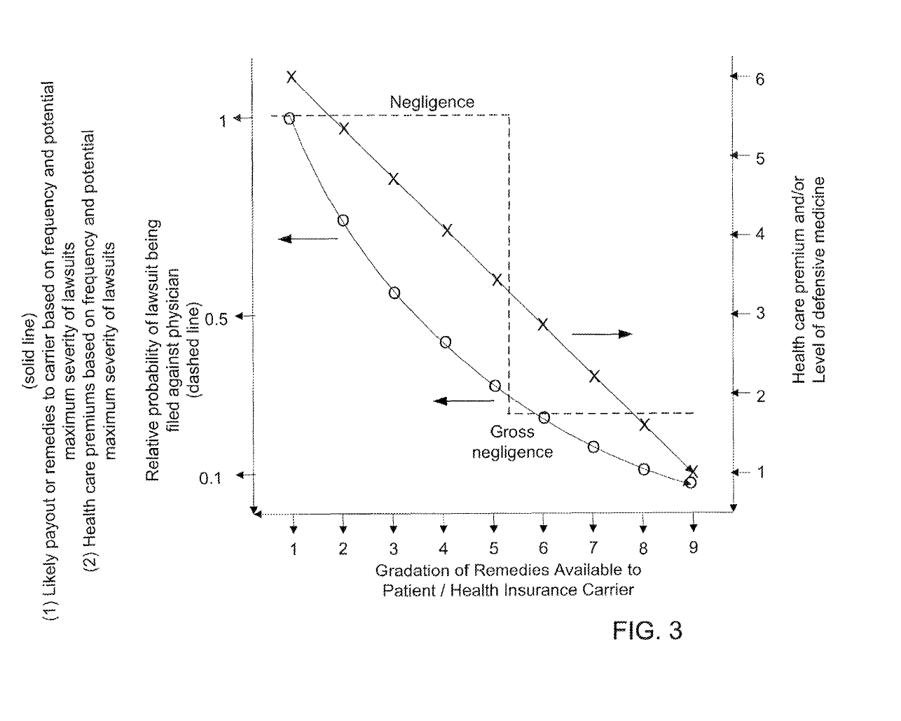

FIG. 3 is a schematic diagram that illustrates the benefits realized in a closed system of the type illustrated in FIG. 1, in which patients are assumed to have assigned/subrogated their rights, and physicians practice in accordance with accepted schemata that implement evidence-based practice guidelines. The diagram shows the interrelationship among the following variables:
(a) The remedies for damages available to a patient or the carrier (plotted on the x-axis) on a scale from 1 to 9, as described with reference to the foregoing table. “1” reflects the traditional tort system, including the availability of unlimited recovery for economic and non-economic injury, plus punitive damages based on a threshold of ordinary negligence. “9” reflects the availability of recovery for only economic damages, based on threshold of gross negligence;
(b) the patient's savings (plotted on the right-hand y-axis) in health care premium, for example. (other substantial savings and incentives could be provided); and
(c) the probability of a lawsuit being filed against a physician (plotted on the left-hand y-axis). The right-hand y-axis of FIG. 3 also reflects the level of defensive medicine—i.e., the lowest premiums are associated with the lowest levels of defensive medicine. It will be understood that these curves are intended only to indicate a general trend and not to represent any quantitative monetary value.

The dashed curve in FIG. 3 indicates a relative probability for ordinary negligence as compared to gross negligence. Gross negligence can be expected to occur much less frequently, is more easily detected, and can be dealt with more quickly through—e.g., suspension of a physician's privileges—than ordinary negligence. In the depicted example, ordinary negligence is assumed to occur with a relative probability P₀ (P₀ here is normalized to 1) and gross negligence with a relative probability of ¼/P₀ or 0.25 (normalized). According to the foregoing table and shown graphically in FIG. 3, varying a physician's susceptibility to damage remedies from 2 to 5 as noted on the x-axis will reduce the remedy available to an injured patient/carrier by first transferring rights to sue to an institutional entity (making filing of suits more predictable and less influenced by emotional motivations) (“#2” on the graph) eliminating punitive damages (“#3” on the graph); and then placing a cap on non-economic damages (variation of “#4” on the graph); and then allowing recovery only for economic damages (“#5” on the graph). Significant benefits are achieved in the health care system as described by elevating the threshold for bringing a lawsuit against the physician from ordinary negligence to gross negligence, which occurs much less frequently.

The rules in the schemata may not be absolute, and some judgments may need to be made even when following the schemata. Therefore, to minimize the risk of a physician being sued and thus realize the maximum savings to the system, a “gross negligence” standard should be applied. If ordinary negligence were be to used as the standard, pain and suffering preferably would need to be capped at a level far lower than currently available in many states. Hence, at the very least, physicians and/or hospitals would save money on their professional liability premiums, although there would be less incentive to avoid practicing defensive medicine under the ordinary negligence standard.

The savings generated by the increased efficiency of a system as described could be used to perform one or more of the following:

1. Recycle the surplus funds into patient-safety systems. Examples include automated prescription systems, computerized calling systems to notify patients of lab results, electronic medical records, computerized physician order entry, computerized clinical decision support, bar-coding of pharmaceuticals, and/or educational sessions addressing same site surgery;

2. Lower health insurance premiums for the consumer;

3. Subsidize, in whole or in part, life, disability or long-term care insurance policies for the insured. Such policies would at least partially compensate injured patients for economic loss;

4. Set up an insurance pool to guarantee future health insurance coverage for those who are negligently injured, at no or little cost to the insured;

5. Other subsidies or services to the consumer, such as mental health benefits, maternity coverage, or subsidies or discounts for health-related services such as health club memberships;

6. Higher reimbursement or salaries for physicians, so that they practice more as “team players.”

In general, the health insurance carrier will have little incentive to sue physicians who acted negligently, but who are otherwise competent and provide services on a daily basis, because such legal action might alienate the physicians and other health care providers in the system. The health insurance carrier, by shielding the physicians from legal action, may therefore further encourage them to avoid practicing defensive medicine. Thus, while prior attempts to discourage the practice of defensive medicine have not been greatly successful, the system as described may achieve that result in at least two ways.

The health insurance carrier might still sue the physician if a higher threshold of negligence is met—e.g., gross negligence or recklessness (willfulness). In such circumstances, the health insurance carrier might transfer some or all of the settlement or judgment received from the liability carrier to the injured patient in accordance with the terms of the insurance policy and the subrogation agreement/assignment.

As a further benefit of the system described, because the payouts related to legal defense, settlements or judgments in the closed system of FIG. 1 would be lower than with a traditional tort system, the premiums paid by physicians and/or hospitals (directly or indirectly) to their liability carriers also may be lower.

In accordance with the described system, any payment related to malpractice would be made only and directly to the health insurance carrier, as the plaintiff, as opposed to the patient. The patient would be made whole, within the limits of his/her coverage, by the health insurance carrier. This might also sidestep the issue of reportability to the National Practitioners' Data Bank. Currently, a physician who settles a case, or loses a verdict and pays a judgment to a patient, is reported to the NPDB. If payment is made to some other legal entity, such reporting is avoided. Physicians often litigate cases that should be settled primarily to avoid being reported to the NPDB.

In a closed system such as that depicted in FIGS. 1 and 2, the savings associated with minimizing the practice of defensive medicine would be expected to be far greater than the sums a carrier could collect under its assigned/subrogated rights, even if the traditional threshold of ordinary negligence is applied. Hence, a more profitable strategy for the carrier would be to use its assigned/subrogated rights primarily to reduce its expenditures (e.g., by having its employed or contracted physicians practice less defensive medicine) rather than to sue physicians to increase its revenue.

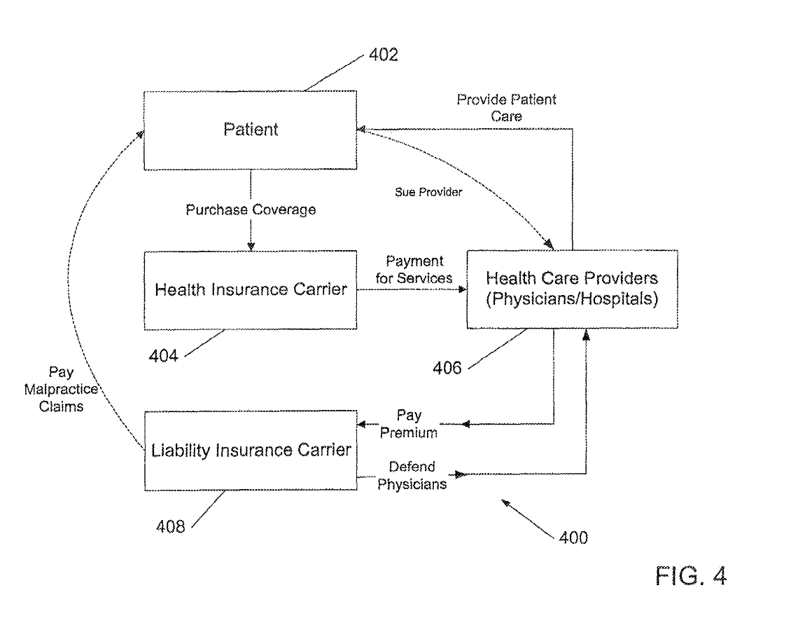

FIG. 4 illustrates an alternative embodiment in which the health care system 400 is “open.” In system 400, unlike in the “closed” system 100 depicted in FIG. 1, health care is not delivered within the context of an integrated corporate system. Here, consumers/patients 402 purchase health insurance coverage from a third party health insurance carrier 404. Health care providers 406, including physicians and hospitals, are independent entities providing services to patients 402. The physicians, hospitals and other health care providers 406 may have negotiated rates as part of a contract with the health insurance carrier 404 for delivery of specific medical services, such as tests and treatments. In the open system 400, the physicians, hospitals and health care providers 406 may purchase liability insurance from a third-party professional liability carrier 408 to defend against lawsuits alleging medical malpractice.

In open system embodiment 400, the health insurance policy purchased by a patient 402 may still include an assignment/subrogation of malpractice claims. Such an assignment/subrogation would be associated with liability insurance carrier 408 paying malpractice claim to health insurance carrier 404 based on rules and limits established in insured patient's (402) policy. And health insurance carrier 404 would still publish guidelines and schemata for diagnosing and treating various conditions. Thus, even though physicians and other providers 406 may not be employed by health insurance carrier 404, the physician or provider 404 still would know that if a patient is insured under that type of policy (as would be known in the industry just as providers now recognize the various forms of indemnity and managed care health insurance and act accordingly), then he/she would have at least some immunity from suit by following that insurer's published guidelines. Thus, physician/provider 406 could safely practice less defensive medicine when caring for such patients, even though other patients with other forms of insurance may be subject to defensive medical practices by that same physician/provider 406. In a further variant of open system 400, similar to current managed care plans, there may be contract between physician/provider 406 and health insurance carrier 404 that formalizes the physician/provider's immunity from suit as long as the published schemata are followed.

An open system 400 is expected to provide less savings than the closed system 100, because each physician/provider 406 is exposed to patients who do not participate in or have opted out of the assignment/subrogation type of policy contemplated by the system described. Although ideally physician/provider 406 would exercise the same level of care with all patients, physician/provider 406 may still practice some degree of defensive medicine because of the possibility that some patients can still directly sue physician/provider 406. This particularly would be the case where the patient carried health insurance that does not include, or that the physician/provider 406 does not recognize as including, the assignment/subrogation/immunity feature.

In a further variation of either a closed system or an open system, the evidence-based schemata can be varied. Some of these variations might be perceived to be more defensive than others, but would still provide cost savings over the traditional medical system. Thus, the closed system might allow for two standards of care for closed head injury. In one, the sensitivity for using CT scans for minor head injury to recognize treatable brain injuries will be targeted at 99%. In the other, the sensitivity for using CT scans for minor head injury to recognize treatable brain injuries will be targeted at 99.9%. The first variation allows for missing one lesion in a hundred. The other variation allows for missing one lesion in a thousand. The frequency of using CT scans for minor head injury will have to increase to achieve this more restrictive constraint. The target of sensitivity of 99.9% can be viewed as “more defensive” than sensitivity of 99%. Nonetheless, in this context, both 99% and 99.9% might be quite reasonable targets.

In such an embodiment which includes a range of schemata or standards of care (each standard being reasonable), there will be gradations of progressively less defensive medicine. The savings associated with such a system can be passed on to a patient/insured depending on which standard the patient/insured chooses. Such savings might include more progressively lower health insurance premiums, larger subsidies for disability or life insurance, greater expenditures for patient safety systems, etc.

As discussed above, health insurance carriers might not want to pursue or manage a claim of professional liability against a physician. That is, the insurance company might not want to be the assignee of a claim of professional liability. Insurance companies instead may want the best possible relationship with physicians who provide services to their insureds. And frequently the relationship between physicians and insurance carriers is already adversarial. Insurance companies might not want to add yet another potential source of contention.

In addition, consumers generally place little trust in health insurance carriers and might not have faith that a carrier would actually prosecute a claim against a physician, even if the physician failed to follow the practice guidelines. The patient might have even greater interest in prosecuting such a case if some or all of money received in settlement or judgment was to be transferred to the patient.

Therefore, in accordance with the invention, health insurance carriers may avoid directly entangling themselves in potential litigation. And patients/consumers would have a mechanism for making sure that legitimate claims in which they have an interest are pursued. These embodiments still provide a number of checks and balances to give physicians the same reasons, as in the embodiments described above, to avoid the practice of defensive medicine, and/or to embrace cost-effective practice guidelines as standards in diagnosis and/or treatment.

In accordance with the invention, as in the embodiments described above:

1. Patients still agree to participate in a system where they transfer rights related to litigation in exchange for a benefit;

2. Physicians still have absolute or practical immunity from lawsuits if they adhere to the cost-effective guidelines; and

3. Insurance companies are able to incentivize physicians to practice cost-effective medicine and/or avoid the practice of wasteful defensive medicine.

In one embodiment, the patient/consumer transfers his/her right to sue to a neutral third party. Such a third party would not be an advocate for the insurance company. Further, it preferably is set up at arm's length from such a carrier. This third party might be a non-profit organization or an entity that is working on or has achieved a reputation for fairness, objectivity, and even-handedness. One or more insurance companies might underwrite the general operational costs for such an organization, much as pharmaceutical companies underwrite some of the costs of the Food and Drug Administration (“FDA”). Nonetheless, in both the neutral third party model, and the example of the FDA, the entity is perceived as being objective and committed to implementation of core principles. That is, the entity is not beholden to the funding source, and can rule against the interest of the funding source.

According to one variant of this embodiment, the neutral third party would first screen a potential case. Based on the result of the screening, the neutral third party could prosecute a claim of negligence against a physician or other health care provider. Or, the neutral third party could release the claim back to the patient, or a representative or beneficiary, and allow him/her to prosecute the claim, either on his/her own, or by using a recommended network of reputable attorneys and/or health professional expert witnesses.

The system is expected to be most efficient if physicians believe that they will be immune from lawsuits by following the schemata. Accordingly, there preferably is an incentive structure based on minimizing the likelihood that patients will file excessive claims of malpractice. Also, the incentive structure is designed to prevent patients/consumers from breaking their agreement to conform to the rules.

In this embodiment, the transfer of the right to pursue a claim of general or gross negligence against a physician or other health care provider may be an exclusive power of attorney to pursue that claim either in court, through arbitration, or any other recognized alternative dispute resolution venue. The grant of this power of attorney to the neutral third party preferably is included in the patient/consumer's contract with the health insurance carrier. Alternatively, as in the embodiments above, the patient/consumer could agree to assign any claim—except that in this embodiment, the assignment would be to the neutral third party rather than to the insurer. Any other type of “transfer,” as defined above, could be made between the patient/consumer and the neutral third party.

The neutral third party will then screen the case for professional liability. Based on the result of that screening, the neutral third party might (a) rule that there is no merit to the underlying claim (i.e., the physician followed the guidelines and is immune from suit and/or there was no evidence of negligence or gross negligence based on an agreed-to standard of preponderance of evidence or clear and convincing evidence, or, less likely, beyond a reasonable doubt); (b) prosecute a claim of negligence or gross negligence against the physician directly (transfer some or all of any judgment or settlement back to the patient, representative, and/or beneficiary); or (c) release power of attorney (or assign the claim back) to allow the patient, representative, and/or beneficiary to pursue the claim on his/her own.

Additional features can be added (in part or in full) to decrease likelihood that patients/consumers, representatives, and/or beneficiaries will pursue claims at higher-than-expected rates.

First, the patient/consumer, representative, and/or beneficiary may be bound by contract to pay some or all of the cost for screening by the neutral third party of a potential case of professional liability. The amount charged may be a flat fee, or a percentage (up to 100%) of the cost of screening and evaluation. The amount charged also may include payment for one or more health professional experts to (a) assist in evaluating case to determine whether the health care provider adhered to practice guidelines, (b) evaluate the case for breach of the standard of care, (c) evaluate the case for causation of damages, (d) evaluate the case for economic damages, and/or (e) evaluate case for non-economic damages. The amount may also include the cost of hiring one or more non-health professional experts to (a) evaluate the case for economic damages, and/or (b) evaluate case for non-economic damages.

Second, the patient/consumer, representative, and/or beneficiary may be bound by contract to pay some or all of the cost for an appeal of a previous ruling of a potential case of professional liability by the neutral third party. Once again, the amount charged may include a flat fee, or may include a percentage (up to 100%) of the cost of the appeal, as well as the cost of hiring one or more health professional experts and/or non-health professional experts to help evaluate the case.

Additional features can be added (in part or in full) to decrease likelihood that patients/consumers, representatives, and/or beneficiaries will ignore their obligation to submit to pre-screening by the neutral third party and initiate litigation directly.

First, the patient/consumer, representative, and/or beneficiary may be bound by contract to pay liquidated damages to the health insurance carrier if he/she does not seek screening by neutral third party before pursuing a claim of professional liability, whether in court, through arbitration, or through any other form of alternative dispute resolution.

Second, the patient/consumer, representative, and/or beneficiary may be bound by contract to reimburse the health insurance carrier for some or all of any attorneys' fees incurred to enforce any agreement if he/she does not seek screening by the neutral third party before pursuing a claim of professional liability, whether the liability claim is pursued in court, through arbitration, or through any other form of alternative dispute resolution.

Third, the patient/consumer, representative, and/or beneficiary may be bound by contract to reimburse the health care provider, the health insurance carrier, and/or the health care provider's professional liability carrier, for some or all of any attorneys' fees incurred to defend any claim of professional liability that is made without the agreed-upon screening by the neutral third party, whether the liability claim is pursued in court, through arbitration, or through any other form of alternative dispute resolution.

Fourth, the patient/consumer, representative, and/or beneficiary may be required to agree contractually that some or all future insurance benefits will be terminated if he/she does not seek screening by the neutral third party before pursuing a claim of professional liability, whether the liability claim is pursued in court, through arbitration, or through any other form of alternative dispute resolution. The terminated future benefits could include health insurance, disability insurance, life insurance, and/or long term care insurance (including access to funds for nervous system disease/injury and/or birth defect/injury).

Fifth, the patient/consumer, representative, and/or beneficiary may be required to agree contractually that some or all insurance benefits will be reimbursed or subrogated for repayment if he/she does not seek screening by the neutral third party before pursuing a claim of professional liability. The payments reimbursed or subrogated may include payments made or to be made by the carrier for health insurance, disability insurance, life insurance, and/or long term care insurance (including access to funds for nervous system disease/injury and/or birth defect/injury).

Additional features can be added (in part or in full) to decrease the likelihood that patients/consumers, representatives, and/or beneficiaries will ignore the result of screening by the neutral third party and initiate a claim even if the result of the screening is a recommendation that no claim be pursued.

First, the patient/consumer, representative, and/or beneficiary may agree contractually in advance that the screening report of the neutral third party will be admissible as evidence, whether in court, in arbitration, or in any other alternative dispute resolution proceeding, and may be treated as an admission by the patient/consumer, representative, and/or beneficiary.

Second, the patient/consumer, representative, and/or beneficiary may be bound by contract to pay liquidated damages to the health insurance carrier if he/she ignores the recommendation of the neutral third party in pursuing a claim of professional liability, whether the claim is pursued in court, through arbitration, or through any other form of alternative dispute resolution.

Third, the patient/consumer, representative, and/or beneficiary may agree contractually to reimburse the health insurance carrier for some or all of any attorneys' fees incurred to enforce any agreement if he/she ignores the recommendation of the neutral third party and pursues a claim of professional liability, whether the claim is pursued in court, through arbitration, or through any other form of alternative dispute resolution.

Fourth, the patient/consumer, representative, and/or beneficiary may be bound by contract to reimburse the health care provider, the health insurance carrier, and/or the health care provider's professional liability carrier, for some or all of any attorneys' fees incurred to defend any claim of professional liability that is made contrary to the recommendation of the neutral third party, whether the liability claim is pursued in court, through arbitration, or through any other form of alternative dispute resolution.

Fifth, the patient/consumer, representative, and/or beneficiary may be required to agree contractually that some or all future insurance benefits may be terminated if he/she ignores the recommendation of the neutral third party and pursues a claim of professional liability, whether the liability claim is pursued in court, through arbitration, or through any other form of alternative dispute resolution. The future benefits that could be terminated may include health insurance, disability insurance, life insurance, and/or long term care insurance (including access to funds for nervous system disease/injury and/or birth defect/injury).

Sixth, the patient/consumer, representative, and/or beneficiary may be required to agree contractually that some or all insurance benefits will be reimbursed or subrogated for repayment if he/she ignores the recommendation of the neutral third party and pursues a claim of professional liability. The payments reimbursed or subrogated may include payments made or to be made by the carrier for health insurance, disability insurance, life insurance, and/or long term care insurance (including access to funds for nervous system disease/injury and/or birth defect/injury).

Additional features can be added (in part or in full) to increase the likelihood that patients/consumers, representatives, and/or beneficiaries will choose reputable attorneys or expert witnesses to pursue claims of professional liability when pursuit of a claim is recommended by the neutral third party. Reputable attorneys and/or expert witnesses should be those who will give physicians comfort that they will receive a fair hearing, not complicated by inflammatory rhetoric or esoteric legal theories which might increase the cost of settlement or judgment. Reputable experts and attorneys also should be those who can be trusted to be consistent, to incentivize physicians to conform, in general, to the practice guidelines.

First, the insurance carrier or neutral third party may develop a network of reputable plaintiff's attorneys who preferably will charge patients/consumers, representatives, and/or beneficiaries a flat fee lower than the market rate for legal services.

Second, the insurance carrier or neutral third party may develop a network of reputable plaintiff's attorneys who will charge patients/consumers, representatives, and/or beneficiaries a discounted hourly rate.

Third, the insurance carrier or neutral third party may develop a network of reputable plaintiff's attorneys who will perform services for patients/consumers, representatives, and/or beneficiaries under a contingency fee arrangement more favorable than market contingency arrangements.

Fourth, the insurance carrier or neutral third party may develop a network of reputable expert witnesses who will charge patients/consumers, representatives, and/or beneficiaries a flat fee lower than market rate for expert witness services.

Fifth, the insurance carrier or neutral third party may develop a network of reputable expert witnesses who will charge patients/consumers, representatives, and/or beneficiaries a discounted hourly rate.

In another embodiment, the neutral third party referred to above, while a separate corporate entity from the health insurance carrier, could be a related company such as a subsidiary of the health insurance carrier, or a company owned partially or fully in common with the health insurance carrier.

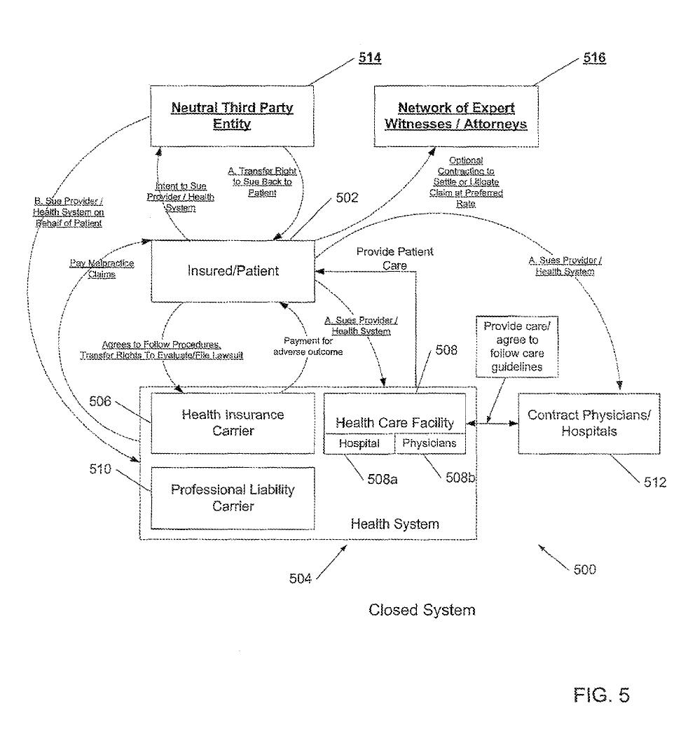

FIG. 5 illustrates schematically an exemplary “closed” system 500 in accordance with an embodiment of the invention, where individuals 502 purchase health insurance coverage from a captive health insurance carrier 506 that is part of an integrated corporate health care system 504. Health care system 504 may include a health care facility 508, such as a hospital 508a, that employs physicians 508b. The health system 504 may also contract with other physicians 512 and other health care facilities 512. In the exemplary “closed” system 500, the health insurance carrier 506 sets and enforces practice guidelines or schemata to which the caregivers 508, 508a, 508b and 512 must adhere if they wish to participate in health care system 504 and receive reimbursement for their services from health insurance carrier 506. The healthcare system 504 may allow caregivers 508, 508a, 508b and/or 512 to deviate from practice guidelines or schemata, but such deviation does not allow for equal protection from liability for the caregiver. Practice guidelines or schemata are ideally developed with physician input and may be modified or added to over time. Health care system 104 may also include a captive professional liability carrier 510 to which the physicians 508b, and possibly physicians 512, directly or indirectly pay a premium for professional liability insurance.

As described below, patients participating in the exemplary closed system 500 will have transferred their rights to directly sue a physician (or to collect any or all of the proceeds of any action), either by assignment, or by grant of an exclusive power of attorney to neutral third party entity 514. The transfer preferably also includes a transfer of the right to institute alternative dispute resolution proceedings including, but not limited to, arbitration. As noted above, “transfer” also may include any other right to pursue the claim or to recover some or all of the proceeds—i.e., any settlement or damage award—of the claim. The professional liability carrier 510 may ultimately pay a claim for malpractice to the health insurance carrier 506 (normally after litigation or by settlement). Such a transferred claim might be triggered based on a physician 508b, 512 failing to adhere to evidence-based guidelines or schemata. Another threshold for advancing such a claim may be either ordinary or gross negligence. The maximum amount of that claim may vary from (a) economic damages only to (b) economic damages plus capped non-economic damages to (c) economic damages plus capped or uncapped non-economic and punitive damages.

Health care system 504 may or may not be self-insured for malpractice liability of its employees (including physicians and others), which may involve ownership of professional liability carrier 510. If system 504 is self-insured, it may or may not purchase liability insurance (stop-loss insurance or reinsurance) to cover events exceeding a certain damage award.

In the closed system 500 of FIG. 5, a patient/consumer 502 preferably would purchase health insurance from health insurance carrier 506 and preferably would transfer rights to neutral third party entity 514 as described above, including rights in the case of negligent or grossly negligent care. The neutral third party entity 514 would screen the case to determine whether caregivers 508, 508a, 508b and/or 512 deviated from practice guidelines or schemata. If neutral third party entity 514 determines that there was deviation from practice guidelines or schemata and that such deviation was associated with negligence or gross negligence, neutral third party entity 514 would have the right to, and might, pursue a claim or receive some or all of proceeds of a claim against caregiver 508, 508a, 508b and/or 512, whether the claim is pursued in court, through arbitration, or through any other form of alternative dispute resolution. Alternatively, neutral third party entity 514 might transfer the right to pursue the claim (whether in court, through arbitration, or through any other form of alternative dispute resolution) against caregiver 508, 508a, 508b and/or 512 back to the patient/consumer 502 (or a representative or beneficiary of patient/consumer 502).

In accordance with the provisions of a particular policy purchased by patient 502, in a case where neutral third party entity 514 pursues the claim on its own behalf, neutral third party entity 514 may subsequently transfer back to patient/consumer 502 some or all of any award/settlement from the physician or healthcare facility (paid by the professional liability carrier 510). Whether the policy provides for any such transfer, and what portion of the award or settlement is transferred, will in part determine the premium paid by patient/consumer 502. As noted, the bar for any such suit would be based on a specific threshold, which could be either ordinary negligence or gross negligence (e.g., willful conduct).

Patient/consumer 502 preferably will have agreed to one or more terms or conditions to decrease the likelihood that a claim will be pursued (whether in court, through arbitration, or through any other form of alternative dispute resolution). Such terms or conditions may include payment of some or all of the costs of having the case screened by neutral third party entity 514. Patient/consumer 502 might also agree to disincentives to ignoring the recommendation or decision of neutral third party entity 514. Patient/consumer 502 might also agree to disincentives to ignoring the obligation to have a claim screened by neutral third party entity 514 before pursuing the claim. Such disincentives may include some or all of (a) payment or some or all of the costs of an appeal (if one is filed) of the recommendation or decision of neutral third party entity 514, (b) payment of liquidated damages, (c) payment of some or all of any attorneys' fees to enforce the agreement(s), (d) payment of some or all of any attorneys' fees to defend caregiver 508, 508a, 508b and/or 512 should the caregivers prevail, (e) termination of some or all future insurance benefits (including health insurance, disability insurance, life insurance, and/or long term care insurance including access to funds for nervous system disease/injury and/or birth defect/injury), (f) subrogation, repayment, or reimbursement of past or future insurance benefits (including health insurance, disability insurance, life insurance, and/or long term care insurance including access to funds for nervous system disease/injury and/or birth defect/injury), (g) agreement that the recommendation or decision of neutral third party entity 514 will be admissible as evidence (including as an admission by patient/consumer 502 (or a representative or beneficiary of patient/consumer 502)).

If after screening the case, neutral third party entity 514 transfers the right to sue back to patient/consumer 502 (or a representative/beneficiary of patient/consumer 502), patient/consumer 502 (or a representative/beneficiary of patient/consumer 502) will have access, if desired, to a network of expert witnesses/attorneys 516 to assist in the prosecution of the claim. Such a network preferably will have a reputation for consistency, and for advancing legitimate claims using traditional legal theories based on generally accepted standards of care. Patient/consumer 502 (or a representative/beneficiary of patient/consumer 502) preferably will be offered incentives to use the network of expert witnesses/attorneys 516. Such incentives may include a flat fee, discounted fees or contingency arrangements more favorable than market arrangements.

Preferably, all physicians participating in the closed system 500 will have agreed to, and undergone training to administer tests and perform procedures in conformance with, the practice guidelines and diagnostic and treatment schemata. Indeed, as a group, they may have substantive input into developing the agreed-upon guidelines. As long as the physicians adhere to these guidelines, they will be protected against any direct lawsuits by neutral third party entity 514, and they will have increased protection against lawsuits by patient/consumer 502 (or a representative or beneficiary of patient/consumer 502). Because a physician who follows the practice guidelines will feel less threatened by a lawsuit, he/she will also have less incentive to perform unnecessary tests and procedures—i.e., he/she will refrain from practicing defensive medicine and will be incentivized to practice cost-efficient medicine. In addition, the physician might receive other tangible benefits from the carrier for complying with the guidelines, such as bonuses, additional compensation, and the like. Such compliance could be measured by audits and the benefits conferred would be based on how well the guidelines were followed, as determined by an established metric.

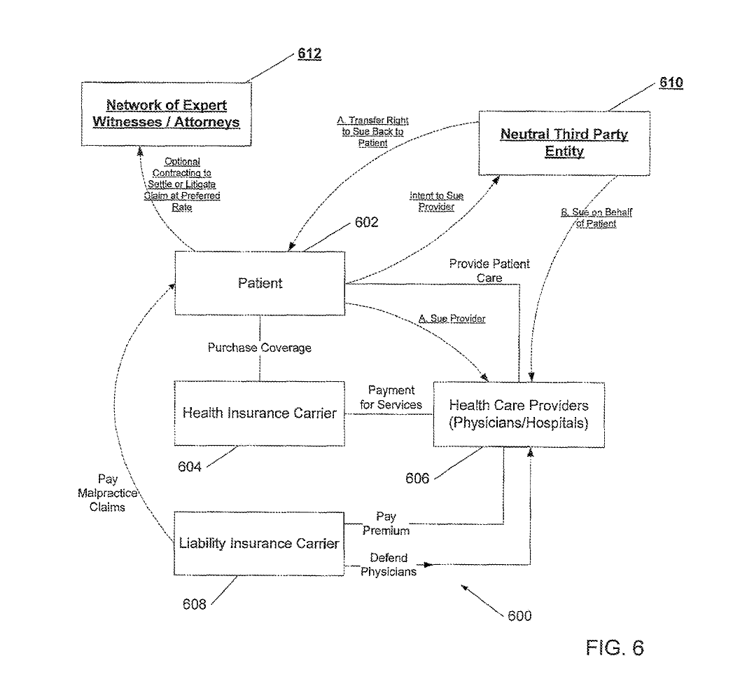

FIG. 6 illustrates an alternative embodiment of the invention in which the health care system 600 is “open.” In system 600, unlike in the “closed” system 500 depicted in FIG. 5, health care is not delivered within the context of an integrated corporate system. Here, patients/consumers 602 purchase health insurance coverage from a third party health insurance carrier 604. Health care providers 606, including physicians and hospitals, are independent entities providing services to patients/consumers 602. The physicians, hospitals and other health care providers 606 may have negotiated rates as part of a contract with the health insurance carrier 604 for delivery of specific medical services, such as tests and treatments. In the open system 600, the physicians, hospitals and health care providers 606 may purchase liability insurance from a third-party professional liability carrier 608 to defend against lawsuits alleging medical malpractice.

In open system embodiment 600, the health insurance policy purchased by a patient/consumer 602 may still include a transfer, as defined above, of the right to pursue (or to receive some or all of the proceeds of a suit for) malpractice claims (whether pursued in court, through arbitration, or through any other from of alternative dispute resolution). Such transfer preferably will be to neutral third party entity 610. Neutral third party entity 610 preferably would screen the case to determine whether health care provider(s) 606 deviated from practice guidelines or schemata. If neutral third party entity 610 determines that there was deviation from practice guidelines or schemata and that such deviation was associated with negligence or gross negligence, neutral third party entity 610 would have the right to and might pursue a claim (or receive some or all of proceeds of a claim) against health care provider(s) 606 (whether in court, through arbitration, or through any other form of alternative dispute resolution). Alternatively, neutral third party entity 610 might transfer the right to pursue a claim against health care provider(s) 606 (whether in court, through arbitration, or through any other form of alternative dispute resolution) back to the patient/consumer 602 (or a representative or beneficiary of patient/consumer 602).

If a settlement/judgment ultimately occurs, the transfer would result in liability insurance carrier 608 paying the malpractice claim to neutral third party entity 610 based on rules and limits established in the insured patient's/consumer's (602) policy. In accordance with the provisions of the particular policy purchased by patient/consumer 602, neutral third party entity 610 may transfer some or all of any award/settlement from the physician or healthcare facility (paid by the professional liability carrier 608) back to patient/consumer 602. Whether the policy provides for any such transfer, and what portion of the award or settlement is transferred, will in part be determined by the premium paid by patient/consumer 602. As noted, the bar for any such suit would be based on a specific threshold, which could be either ordinary negligence or gross negligence (e.g., willful conduct). In addition, as also noted, the evidentiary standard for prevailing might also vary as between preponderance of evidence and clear and convincing, or even possibly beyond a reasonable doubt.

Patient/consumer 602 preferably will have agreed to one or more terms or conditions to decrease the likelihood that a claim will be pursued (whether in court, through arbitration, or through any other form of alternative dispute resolution). Such terms or conditions may include payment of some or all of the costs of having the case screened by neutral third party entity 610. Patient/consumer 602 might also agree to disincentives to ignoring the recommendation or decision of neutral third party entity 610. Patient/consumer 602 might also agree to disincentives to ignoring the obligation to have a claim screened by neutral third party entity 610 before pursuing a claim. Such disincentives may include some or all of (a) payment or some or all of the costs of an appeal (if one is filed) of the ruling of neutral third party entity 610, (b) payment of liquidated damages, (c) payment of some or all of any attorneys' fees to enforce agreement(s), (d) payment of some or all of any attorneys' fees to defend health care provider(s) 606 should they prevail, (e) termination of some or all future insurance benefits (including health insurance, disability insurance, life insurance, and/or long term care insurance including access to funds for nervous system disease/injury and/or birth defect/injury), (f) subrogation, repayment, or reimbursement of some or all of past or future insurance benefits (including health insurance, disability insurance, life insurance, and/or long term care insurance including access to funds for nervous system disease/injury and/or birth defect/injury), (g) agreement that the ruling of neutral third party entity 610 will be admissible as evidence (including as an admission by patient/consumer 602 (or a representative or beneficiary of patient/consumer 602)).

If after screening the case, neutral third party entity 610 transfers the right to sue back to patient/consumer 602 (or a representative/beneficiary of patient/consumer 602), patient/consumer 602 (or a representative/beneficiary of patient/consumer 602) preferably is given access to a network of expert witnesses/attorneys 612 to assist with prosecution of the claim. Such a network preferably will have a reputation for consistency, and for advancing legitimate claims using traditional legal theories based on generally accepted standards of care. Patient/consumer 602 (or a representative/beneficiary of patient/consumer 602) preferably will be offered incentives to use the network of expert witnesses/attorneys 612. Such incentives may include a flat fee, discounted fees or contingency arrangements more favorable than market arrangements.

Preferably, health insurance carrier 604 would still publish guidelines and schemata for diagnosing and treating various conditions. Thus, even though physicians and other providers 606 may not be employed by health insurance carrier 604, the physician or provider 606 still would know that if a patient is insured under that type of policy (as would be known in the industry just as providers now recognize the various forms of indemnity and managed care health insurance and act accordingly), then he/she would have at least some immunity from suit by following that insurer's published guidelines. Thus, physician/provider 606 could safely practice less defensive and/or more cost-effective medicine when caring for such patients, even though other patients with other forms of insurance may be subject to defensive medical practices by that same physician/provider 606. In a further variant of open system 600, similar to current managed care plans, there may be a contract between physician/provider 606 and health insurance carrier 604 and/or neutral third party entity 610 that formalizes the physician/provider's immunity from suit by neutral third party entity 610 as long as the published schemata are followed.

An open system 600 is expected to provide less savings than the closed system 500, because each physician/provider 606 is exposed to patients who do not participate in or have opted out of the claim-transfer type of policy contemplated by the invention. Although ideally physician/provider 606 would exercise the same level of care with all patients, physician/provider 606 may still practice some degree of defensive medicine because of the possibility that some patients can still directly sue physician/provider 606. This particularly would be the case where the patient carried health insurance that does not include, or that the physician/provider 606 does not recognize as including, the transfer/immunity feature.

In a further variation of either a closed system or an open system, the evidence-based schemata can be varied. Some of these variations might be perceived to be more defensive than others, but would still provide cost savings over the traditional medical system. Thus, for example, the closed system might allow for two standards of care for closed head injury. In one, the sensitivity for using CT scans for minor head injury to recognize treatable brain injuries will be targeted at 99%. In the other, the sensitivity for using CT scans for minor head injury to recognize treatable brain injuries will be targeted at 99.9%. The first variation allows for missing one lesion in a hundred. The other variation allows for missing one lesion in a thousand. The frequency of using CT scans for minor head injury will have to increase to achieve this more restrictive constraint. The target of sensitivity of 99.9% can be viewed as “more defensive” than sensitivity of 99%. Nonetheless, in this context, both 99% and 99.9% might be quite reasonable targets.

In such an embodiment which includes a range of schemata or standards of care (each standard being reasonable), there will be gradations of progressively less defensive medicine. The savings associated with such a system can be passed on to a patient/insured depending on which standard the patient/insured chooses. Such savings might include more progressively lower health insurance premiums, larger subsidies for disability or life insurance, greater expenditures for patient safety systems, etc.

It should be noted that in both closed system 500 and open system 600, neutral third party 514/610 may be either completely independent of health insurance carrier 506/604, or may, while being a separate corporate entity, actually be related to health insurance carrier 506/604. Thus, neutral third party 514/610 may be a partly- or wholly-owned subsidiary of health insurance carrier 506/604, or health insurance carrier 506/604 and neutral third party 514/610 may be commonly owned in whole or in part by one or more other parties. In closed system 500, those other parties could include health care system 504.

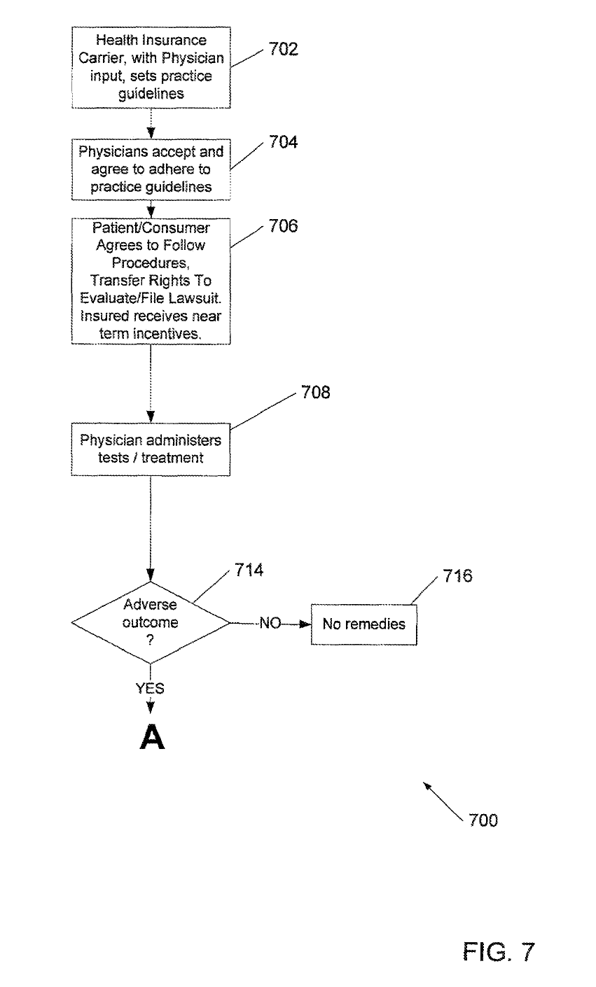

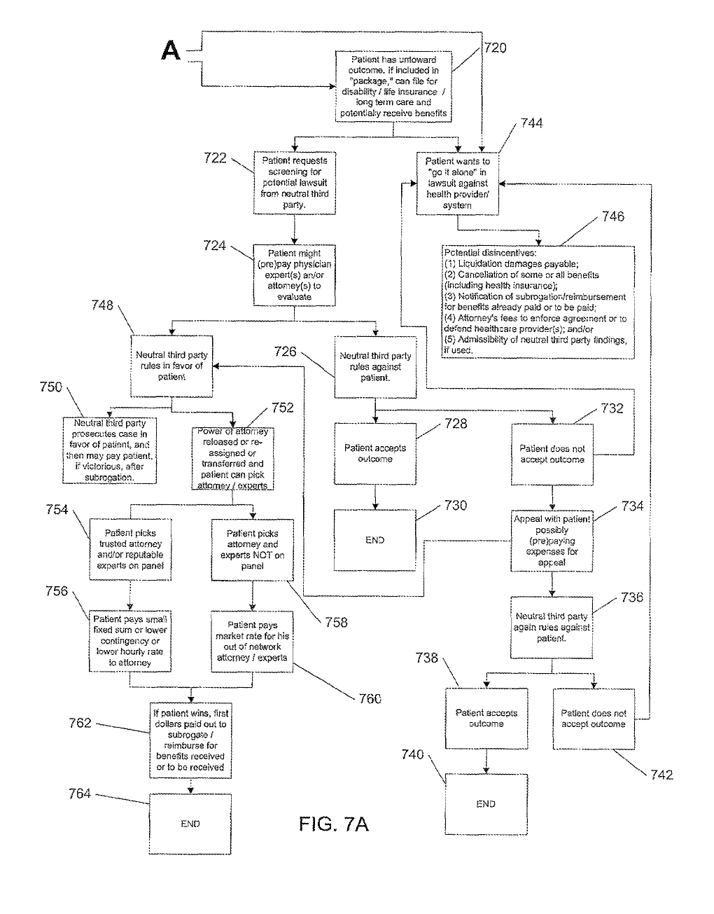

FIG. 7 shows in the form of a process flow chart an exemplary process 700 for administering a system such as system 500 of FIG. 5 or system 600 of FIG. 6. At step 702, the health insurance carrier (preferably with physician input) sets practice guidelines or defines diagnostic and treatment schemata which are cost-efficient, and the physicians participating in the health system agree at step 704 to follow the guidelines. As a result, a patient can be reasonably assured to receive proper treatment provided that the guidelines are followed. If guidelines are not followed, the physician should, if possible, document why he chose to follow that path. At step 706, an insured/patient (at that point, also a consumer) transfers his rights to pursue a legal claim or receive some or all proceeds from a claim. Further, he agrees that no lawsuit (“lawsuit” or “suit” in this description of FIG. 7 is meant to also include any recognized form of alternative dispute resolution such as arbitration) will be brought in his/her name directly or indirectly (e.g., for loss of consortium by a spouse) in the event of an adverse outcome of a treatment.

After transferring his/her rights at step 706, the patient, unless he/she breaches the agreement, will not have any direct cause of action against the physician should he/she be injured. The patient may receive one or more of the following forms of consideration for the transfer: (a) lower health insurance premiums; (b) a subsidy for disability, life or long-term insurance (including access to funds for nervous system disease/injury and/or birth defects/injury); and/or (c) a guarantee that funds are recycled into systems that support or promote patient safety (including systems such as electronic medical records, computerized physician order entry, computerized clinical decision support, and/or bar-coding of pharmaceuticals). Further, the health insurance carrier might continue to provide guaranteed renewability or payment for general coverage for the injured patient for some time period in the future (i.e., the carrier might provide continued coverage without the injured patient having to pay additional premiums in the future).

At step 708, the physician in performing his/her duties administers certain tests or therapeutics, ideally in compliance with the diagnostic and treatment schemata—i.e., commensurate with a particular diagnosis and set of circumstances (such as the patient's overall health, age, etc.).

If the patient does not have an adverse outcome from any cause (step 714), there is no remedy (step 716). If the patient does have an adverse outcome (step 714), and if part of the consideration included disability, life insurance, and/or long-term care insurance (including funds to address nervous system injury or birth injury/defects), he (or an agent/beneficiary) can make a claim to access those benefits (step 720). Regardless of whether a claim is made for any or all of those benefits, the patient (in this description of FIG. 7, “patient” refers to patient, agent, family member, and/or beneficiary) shall be able to request screening for potential lawsuit/settlement from a neutral third party (step 722). The schema may include mechanisms to decrease the filing of ambiguous or meritless claims such as the requirement that the patient pay for some or all of the costs associated with the neutral third party screening such a case (step 724). Such costs might include fees for attorney(s), expert witness(es), and general administrative expenses. The neutral third party might rule in favor of the patient (step 748) or against the patient (step 726). If the neutral third party rules against the patient (step 726) (that is, they believe that (a) the physician followed the diagnostic and treatment schemata and/or (b) there was no evidence of negligence or gross negligence based on one of the following predetermined evidentiary standards—preponderance of evidence or clear and convincing evidence, or possibly even beyond a reasonable doubt), the patient might accept the outcome (step 728) and proceed no further (step 730). Alternatively, the patient might not accept the outcome (step 732) and either (a) appeal the decision, being required according to the agreement to pay none, some, or all of the expenses of the appeal (step 734); or (b) “go it alone” notwithstanding the agreement, to pursue a lawsuit against the health provider/health care system (step 744). (To “go it alone” means to attempt to assert perceived residual rights in filing his/her own lawsuit with or without the assistance of counsel.) The patient may have decided earlier in process 700 to “go it alone” by not requesting the neutral third party to even screen the case (after step 718, whether or not the patient attempted to access benefits).

If the patient's appeal does not change the outcome (step 736), the patient might accept the outcome (step 738), and proceed no further (step 740). Alternatively, the patient might not accept the outcome (step 742), and “go it alone” notwithstanding the agreement to pursue a lawsuit against the healthcare provider/health care system (step 744).

If the patient's appeal does change the outcome (step 748), process 700 continues as described below.

Regardless of the steps leading to “going it alone” (step 744), additional disincentives (step 746) triggered by “going it alone” may be triggered. Such steps might include some or all of (a) payment of liquidated damages, (b) cancellation of some or all benefits (or portion of individual benefits), such as health insurance, disability insurance, life insurance, and long-term care insurance (including access to funds for nervous system disease/injury and/or birth defects/injury); (c) subrogation/reimbursement of some or all benefits already paid or to be paid to the patient, (d) payment of some or all of any attorneys' fees to be paid to enforce the agreement or defend the healthcare provider(s)/healthcare system, and (e) if the neutral third party process was used, to make the conclusions of that process admissible as evidence, or even as an admission by the patient, in the lawsuit.

Revisiting step 748 where the neutral third party might rule in favor of the patient, the party may prosecute the case for the patient, and if victorious, transfer none, some, or all of any settlement/judgment to the patient (step 750). The neutral third party might hold back funds or set the stage to allow for reimbursement/subrogation of benefits that have been paid or will be paid, be they health insurance, disability insurance, life insurance, and/or long term care insurance (including access to funds for nervous system disease/injury and/or birth defects/injury). Alternatively, after step 748, the neutral third party might transfer rights back to the patient to allow him to pursue a claim on his own (step 752). Such a transfer could occur by (a) re-assignment (including cancelling the original assignment) of the potential claim or rights to the proceeds of the claim, or (b) releasing and/or transferring power of attorney back to the patient. After step 752, the patient preferably will be given a choice to use a trusted panel of expert witness(es) and/or attorney(s) (step 754). Using such a panel would create greater predictability in the system as straightforward testimony and generally accepted legal theories will be more likely to be pursued. Such predictability will ensure greater likelihood that physicians will be incentivized to practice according to cost-effective diagnostic and treatment schemata. Step 724 (payment for screening panel expenses), step 734 (payment for screening panel expenses in appeal), and/or step 746 (disincentives to “go it alone”) can also create greater predictability in the system that the patient will follow the rules. Such predictability will likewise ensure greater likelihood that physicians will practice according to cost-effective diagnostic and treatment schemata. The patient may receive incentives to use the panel (step 756), such incentives including (a) paying a reasonably low fixed fee, (b) discounted hourly rate to expert witnesses and/or attorneys, and/or (c) attorney contingency arrangements more favorable market arrangements.

If after step 752 the patient opts to avoid using the panel, he may hire a legal team/experts on his own (step 758). The disincentive to doing so would be that he would have to pay market rate, which presumably would be higher than the panel rates (step 760). Regardless of which team he hires, if the patient is victorious, he will likely receive an award from settlement or judgment (step 762). Some, most, or all of that settlement may be subject to subrogation or reimbursement for benefits he received or will receive. Once there is a transfer of money, that portion of process 700 terminates (step 764).

It is evident that in process 700 few, if any, remedies based on proving fault are available to a patient alleging improper care if the physician follows the established practice guidelines and treatment schemata. The system is designed to directly or indirectly decrease the likelihood that the patient will try to file a lawsuit without following the rules. As the physician benefits from substantial immunity by adhering to the guidelines, (and as the physician has confidence that the patient will not be able to easily file a lawsuit by sidestepping the rules) this will entice the physician to refrain from practicing “defensive medicine” while being incentivized to practice cost-effective medicine. Process 700 does allow for possible access to no-fault remedies to address concerns patients have to “being made completely or partially whole” as well as mitigating the financial effects of untoward results related to medical care, disease progression, or bad luck (step 720).

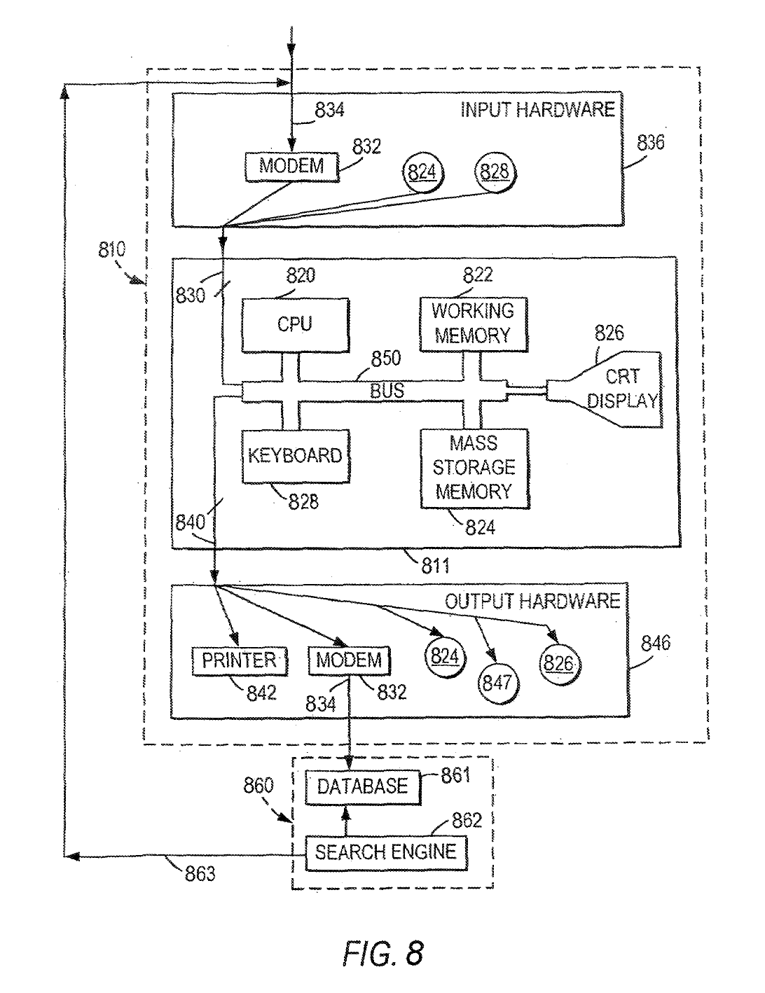

An exemplary computer hardware system 810 with which the present invention may be implemented is shown in FIG. 8. In FIG. 8, which shows a preferred embodiment of apparatus according to the invention, system 810 includes a computer 811 comprising a central processing unit (“CPU”) 820, a working memory 822 which may be, e.g., RAM (random-access memory) or “core” memory, mass storage memory 824 (such as one or more disk drives or CD-ROM drives), one or more cathode-ray tube (“CRT”) display terminals 826, one or more keyboards 828, one or more input lines 830, and one or more output lines 840, all of which are interconnected by a conventional bidirectional system bus 850.

System 810 can be used to take applications and issue policies. System 810 can also be used to keep track of the receipt of signed assignment/subrogation agreements from patients/consumers who purchase policies. In the event of a patient injury resulting a claim against the physician or other health care provider, system 810 can be used to track the claim. If a determination is made (see FIG. 7) that a relevant practice guideline has not been followed, resulting in an entitlement to sue, the litigation can be tracked and, in the event of a settlement or award, system 810 can be used to process any payment to which the health insurance carrier or patient may be entitled or to administer any other policy, such as a life, disability or long-term care policy, or period of free medical care or paid up health insurance premiums, to which the patient may be entitled as a result of the injury.

Input hardware 836, coupled to computer 811 by input lines 830, may be implemented in a variety of ways. Modem or modems 832, which also may be routers or other computer-to-computer communications devices, connected by a telephone line or dedicated data line (such as a T1 or T3 line) 834 can be used to allow direct dial-up access. Modems/routers 832 also may be used to allow access from the Internet. Alternatively or additionally, the input hardware 830 may comprise CD-ROM drives or disk drives 824. In conjunction with display terminal 826, keyboard 828 may also be used as an input device. For example, application data, underwriting data from an underwriter, or guideline adherence data from a reviewer, may be entered through one or more keyboards 828.

Output hardware 846, coupled to computer 811 by output lines 840, may similarly be implemented by conventional devices. By way of example, output hardware 846 may include CRT display terminal 826 for displaying, e.g., the premium to be charged or whether or not an application is approved or a lawsuit is authorized against a health care provider. Output hardware 846 might also include a printer or other printing device 842, so that hard copy output may be produced, or a disk drive 824, to store system output for later use.

Output hardware 846 preferably also includes a payment unit 847 for disbursing funds to health insurance carriers or patients who are entitled to payment of part or all of an award as discussed above. Payment unit 847 could be a check printer if payment is made by check. Alternatively, payment unit 847 could be an electronic funds transfer unit that, using modem/router 832, communicates with the carrier's bank and the patient's bank to transfer funds directly to the patient's account.

In operation, CPU 820 coordinates the use of the various input and output devices 836, 846, coordinates data accesses from mass storage 824 and accesses to and from working memory 822, and determines the sequence of data processing steps.

In summary, methods and systems are described which first and foremost provide an insured with medical care that complies with accepted evidence-based practice guidelines and follows defined diagnostic and treatment schemata. The patient would assign/subrogate claims in exchange for pecuniary benefits, such as lower health insurance premiums. A physician/provider who adheres to the established practice guidelines would be largely shielded from lawsuits. With the lessened threat of legal action, the physician would then be less inclined to practice “defensive medicine,” which would in turn significantly reduce the overall health care costs without diminishing the quality of medical care.

While the invention has been disclosed in connection with the preferred embodiments shown and described in detail, various modifications and improvements thereon will become readily apparent to those skilled in the art.

What is claimed is:

1. A method for deterring practice of defensive medicine by health care providers, said method comprising:
a health insurance carrier defining and disseminating practice guidelines for rendering medical care;
said health insurance carrier issuing to a patient a plan of health insurance, including securing from said patient transfer to a neutral third party of any professional liability claim that arises against any health care provider; and
said neutral third party refraining from asserting any professional liability claim against any health care provider that adheres to said practice guidelines.

2. The method of claim 1 wherein said transfer prevents the patient from suing the physician directly.

3. The method of claim 2 wherein after evaluating said claim, said neutral third party transfers said claim back to said patient.

4. The method of claim 3 further comprising, after said neutral third party transfers said claim back to said patient:
providing to said patient a choice from a panel of at least one of (a) attorneys, and (b) experts; and
offering to said patient an incentive to select at least one of an attorney and an expert from said panel.

5. The method of claim 1 wherein the transfer allows the neutral third party to sue the health care provider in the event of negligence on the part of the health care provider.

6. The method of claim 5 wherein the neutral third party recovers from the health care provider at least a defined limit of damages suffered by a patient and sustained due to negligence by the health care provider.

7. The method of claim 5 wherein the neutral third party is allowed to recover damages from the health care provider only if a predetermined threshold level of negligence has occurred.

8. The method of claim 7 wherein at least a portion of damages recovered by said neutral third party is transferred to one of (a) said patient, (b) said patient's family, and (c) said patient's designee.

9. The method of claim 8 wherein said portion of damages is inversely proportional to incentives received by said patient for said transfer of said claim.

10. The method of claim 1 wherein said health care provider receives from said health care insurance carrier an incentive to adhere to said practice guidelines.

11. The method of claim 10 wherein said adherence is determined based on audit.

12. The method of claim 1 wherein said patient receives from said health care insurance carrier an incentive in exchange for said transfer.

13. The method of claim 1 wherein said patient is subject to a disincentive if said patient ignores terms of said transfer.

14. The method of claim 1 wherein said practice guidelines specify tests, therapies and recommendations for referrals established to maintain a standard of care to maintain at least one of a defined goal of patient safety, a defined level of diagnostic sensitivity, and a therapeutic goal for a specific medical condition.

15. The method of claim 14 wherein there is a gradation of defined levels of said practice guidelines.

16. The method of claim 15 further comprising offering to an insured an incentive for choosing one of said defined levels of said practice guidelines.

17. The method of claim 1 further comprising implementation of patient safety systems.

18. The method of claim 1 further comprising said health care provider agreeing to adhere to said practice guidelines.

19. Apparatus for deterring practice of defensive medicine by health care providers, said apparatus comprising:
a practice guideline unit for defining and disseminating practice guidelines for rendering medical care;
an issuing unit adapted to issue to a patient a plan of health insurance, including securing from said patient transfer to a neutral third party of any professional liability claim that arises against any health care provider;
a claims unit adapted to accept a report, from a covered patient, of a claim of injury resulting from alleged violation of said practice guidelines by a health care provider;
a claims review unit comprising an output and an input device, wherein:
for each report received of a professional liability claim from a covered patient:
said output device flags said report for review by said neutral third party for making a determination of whether said health care provider adhered by said practice guidelines.

20. The apparatus of claim 19 wherein said issuing unit requires said health care professional to agree to adhere to said practice guidelines.

21. The apparatus of claim 19 further comprising a printer adapted to print a certificate evidencing coverage for each patient accepted for coverage under said plan of insurance.

22. The apparatus of claim 19 wherein said claim review unit receives notice from said neutral third party when said neutral third party initiates a lawsuit against said health care provider.

23. The apparatus of claim 22 wherein:
said claim review unit receives notice from said neutral third party of an award against, or settlement with, said health care provider in said lawsuit; said apparatus further comprising:
a disbursement unit adapted to disburse funds to said patient on the occasion of said award or settlement in said lawsuit.

24. The apparatus of claim 23 wherein said disbursement unit disburses funds a portion of said award or settlement according to a level of coverage purchased by said patient.
